(19) United States
(12) Patent Application Publication
(10) Pub. No.: US 2010/0262381 A1
(43) Pub. Date: Oct. 14, 2010

(54) Method of manufacturing and testing solid dosage products and apparatus for the testing

(76) Inventor: William B. Zeng, Indianapolis, IN (US)

Correspondence Address: WILLIAM B. ZENG, P.O. BOX 269035, INDIANAPOLIS, IN, 46226-9035, US

(21) Appl. No.: 12/821,359

(22) Filed: Jun. 23, 2010

Related U.S. Application Data
(63) Continuation-in-part of application No. 12/214,909, filed on Jun. 24, 2008, now abandoned.
(60) Provisional application No. 60/937,755, filed on Jun. 29, 2007.

(51) Int. Cl. G06F 19/00; G01G 9/00

(52) U.S. Cl. 702/23; 73/865

(57) ABSTRACT

A method of manufacturing a solid dosage product includes the controlling of a measure of each of at least one property of dissolution of an ingredient of a sample of the solid dosage product, the measure of each of said at least one property being in an advantageous form and/or controlled in an advantageous manner, e.g., as a function of cumulative mass of the ingredient dissolved from the solid dosage product, and/or as determined under a member of certain advantageous dissolution conditions. A method of testing includes the determining and the evaluating of the measure of each of the at least one property in the advantageous form and/or in an advantageous manner. A dissolution testing cell includes features of construction advantageous for the determining A dissolution testing apparatus includes features of construction and combination of parts and components advantageous for use with the cell in the determining

This is a continuation-in-part of prior application Ser. No. 12/214,909 filed on Jun. 24, 2008, now abandoned, which claims priority of provisional application Ser. No. 60/937,755 filed on Jun. 29, 2007, now expired.

### SUMMARY OF THE INVENTION

The present invention relates to method of manufacturing and testing solid dosage products and apparatus for the testing. More particularly, it relates to method of manufacturing a solid dosage product to achieve a desired or targeted rate of dissolution of an ingredient thereof in vivo and bioavailability/bioequivalence of the ingredient, method of testing for the manufacturing, and apparatus for the testing. It also relates to solid dosage products of such desired or targeted rate of dissolution and bioavailability/bioequivalence.

The method of manufacturing in accordance with a principal feature of the invention, over-coming one or more problems of the prior art, comprises the controlling of a measure of each of at least one property of dissolution of an ingredient of a sample of the solid dosage product, the measure of each of said at least one property being in an advantageous form and/or controlled in an advantageous manner heretofore unattained by the prior art. The method of testing comprises the determining and the evaluating of the measure of each of said at least one property in the advantageous form and/or in an advantageous manner. The solid dosage products are manufactured by way of a method comprising the controlling.

In certain preferred embodiments of the invention, a property is determined and evaluated, or controlled, as a function of a measure of cumulative mass of the ingredient dissolved from a sample of the solid dosage product.

In certain other preferred embodiments, a property is determined and evaluated, or controlled, as a function of both the measure of cumulative mass and a measure of time of contact between the sample and a dissolution medium (hereinafter sometimes, “contact time with dissolution medium”, “dissolution medium contact time”, or simply “contact time”), the measure of contact time being independently variable from the measure of cumulative mass.

A function of, at least, a measure of cumulative mass of an ingredient dissolved from a sample of a solid dosage product, is called, hereinafter sometimes, an “advantageous function”.

One of the at least one property of dissolution, as a said advantageous function, heretofore until the present invention undetermined and unevaluated, nor controlled, as such in methods of manufacturing and testing in the prior art, is called, hereinafter sometimes, an “r(M) function”. In contrast to the determining and the evaluating, or the controlling, of differential rate of dissolution and cumulative mass dissolved, each as a function of time of a dissolution process, which are taught by prior art methods, a method of the present invention, in preferred embodiments thereof, teaches the determining and the evaluating, or the controlling, of differential rate r of an ingredient of a sample of a solid dosage product, as a function, r(M), of cumulative mass M of the ingredient dissolved from the sample of the solid dosage product, the determining being empirically determining (the terms “sample”, “determining”, “evaluating”, “controlling”, and “empirically determining”, are as defined in the present specification). Preferably and advantageously, an r(M) function is determined and evaluated, or controlled, as measured under a given homogenous or pseudo-homogenous (hereinafter, in short, homogenous) dissolution condition in vitro. The in vitro dissolution condition either directly simulates experimentally a component dissolution condition of an in vivo dissolution process, or produces a rate of dissolution physically related preferably linearly to the rate of dissolution under the component dissolution condition (hereinafter, in short, simulates the component dissolution condition). Preferably further, an r(M) function is determined and evaluated, or controlled, under each of a plurality of different such homogenous in vitro dissolution conditions. The plurality of different such homogenous in vitro dissolution conditions comprises a member hereinafter sometimes called a fundamental hydrodynamic dissolution condition selected from the group consisting of: (A.) discrete settlement hydrodynamic dissolution condition; (B.) discrete fluidization and settlement hydrodynamic dissolution condition; (C.) pressure-sensitive packed bed hydrodynamic dissolution condition; and (D.) flow-sensitive fixed position hydrodynamic dissolution condition.

Differential rate, r, determined under a given dissolution condition and evaluated as a said advantageous function comprising further an independent variable of dissolution medium contact time, t_{c}, in accordance with a preferred embodiment of the invention, provides a said advantageous function hereinafter sometimes called an “r(M,t_{c}) function”.

Differential rate, r, determined and evaluated as a function of M and a co-independent variable (i.e., an independent variable that is dependent on another or other independent variables in a composite function) of the dissolution medium contact time, t_{c}, for, e.g., a given dissolution process (i.e., under a full course of time-function of dissolution condition thereof), where t_{c} is identical as time of the dissolution process t, which is dependent on M, i.e., co-varies therewith given the dissolution process, provides a function hereinafter sometimes called an “r(M,t_{c}) curve”.

While each of an M(t) and an r(t) function is generally the property of a dissolution process, an r(M) function determined and evaluated under a given dissolution condition (including t_{c} where r depends on t_{c}) in accordance with a preferred embodiment of the invention, and an r(M,t_{c}) function in accordance with another preferred embodiment thereof, are substantially independent of a dissolution process, and represent a static and intrinsic property of a dissolving solid dosage product in any dissolution process comprising a component dissolution condition simulated by the given dissolution condition.

An r(M) function, determined and evaluated in accordance with a preferred embodiment of the invention, under a member of certain dissolution conditions (including t_{c} where r depends on t_{c}), may be used to characterize fundamental aspects, e.g., dominant mechanism and pseudo kinetic orders, of the dissolution of a solid in a dissolution process, and surface area change, among others.

An r(M) function, computed as a linear combination of r(M) functions determined in vitro under a plurality of different given dissolution conditions, may be used to simulate a rate function of a dissolution process such as an in vivo process comprising component dissolution conditions simulated by the plurality of different given dissolution conditions. Variability of the computed r(M) function may be used as a metric of variability of product dissolution in the dissolution process.

The disclosure herein teaches the treating of a complex hydrodynamic dissolution condition typically found in an in vivo biological dissolution process or environment, as a combination, or a mixture, of component hydrodynamic dissolution conditions comprising all or some of said fundamental hydrodynamic dissolution conditions, in accordance with preferred embodiments of the invention.

The disclosure herein further teaches that, in accordance with preferred embodiments of the invention, differential rate of dissolution of an ingredient of a solid dosage product dissolving in a complex in vivo dissolution process in a complex in vivo dissolution environment, such as the lumenal environment of the gastrointestinal (GI) tract of a live human, at any time of the in vivo dissolution process, may be expressed essentially as a linear combination (or alternatively termed, weighted average) of differential rates of dissolution, each as a said advantageous function, of the ingredient of the solid dosage product dissolving under a plurality of simpler in vitro dissolution conditions each simulating a component dissolution condition of the complex in vivo dissolution process or environment. Given the in vivo dissolution environment, and transit properties of the solid dosage product therein, a collection of the differential rates of dissolution under the in vitro e.g. fundamental hydrodynamic dissolution conditions, each as a said advantageous function, essentially determines the differential rate of dissolution in the in vivo dissolution environment. Controlling of transit properties and the differential rates of dissolution under the in vitro e.g. fundamental hydrodynamic dissolution conditions, each as a said advantageous function, provides, in accordance with an advantageous feature of the invention, a basis for the controlling of differential rate of dissolution in the in vivo dissolution environment.

Another of said at least one property of dissolution, as a said advantageous function, heretofore until the present invention undetermined and unevaluated, nor controlled, as such in methods of manufacturing and testing a solid dosage product in the prior art, is called, hereinafter sometimes, vertical velocity of fluidization. In accordance with the teaching of the invention, vertical velocity of fluidization in an in vivo dissolution medium or an in vitro dissolution medium substantially simulating the in vivo dissolution medium, is a fundamental property of particulates of a dissolving solid dosage product that, when controlled together with the control of an approximate size and cohesiveness of the particulates, allows the control of transit properties thereof in a complex in vivo dissolution environment. In accordance with the teaching of the invention, control of vertical velocity of fluidization of a particulate controls probability of the particulate dissolving in a fluidized state, in contrast to a settled state, at any given point of time of an in vivo dissolution process, given a hydrodynamic dissolution condition thereof and given an in vivo dissolution medium thereof. As will be seen in the present disclosure, a particulate dissolving in a fluidized state is subject to a relative local velocity of dissolution medium flow governed by parameters different from a settled state, which may result in different rates of dissolution of an ingredient of the particulate. In accordance with the teaching of the invention, control of vertical velocity of fluidization controls relative local velocity of dissolution medium flow for a particulate dissolving in a fluidized state, and thereby controls, in part, rate of dissolution of the particulate in the fluidized state.

Another of said at least one property of dissolution, as a said advantageous function, heretofore until the present invention undetermined and unevaluated, nor controlled, as such in methods of manufacturing and testing in the prior art, is specific hydraulic conductivity or specific hydraulic resistance of a particulate or particulates of a solid dosage product containing an ingredient of interest. In accordance with the teaching of the invention, control of the specific hydraulic conductivity or specific hydraulic resistance allows substantial control of rate of dissolution of the ingredient dissolving from the particulate or particulates in a settled state.

Controlling of area under the curve, or volume under the surface, of a member of the above mentioned properties of dissolution plotted against, at least, a measure of the cumulative mass dissolved, allows the controlling of a mean value of the selected property over the, at least, a measure of the cumulative mass, in accordance with a preferred embodiment of the invention.

Equivalent to the determining and the evaluating of a linear combination of differential rates of dissolution under in vitro dissolution conditions simulating component dissolution conditions of an in vivo dissolution process for a computational simulation of in vivo rate of dissolution, a direct experimental simulation of the rate of the in vivo dissolution process is performed in an in vitro dissolution process under a cyclic dissolution condition in accordance with a preferred embodiment of the invention. The cyclic dissolution condition consists of cycles each thereof consisting of a time-series of dissolution conditions each thereof simulating a different member of the component dissolution conditions for a relative duration to length of cycle reflecting probability of occurrence of the different member at a point of time in the in vivo dissolution process equal to a point of time of the cycle in the in vitro dissolution process. The relative duration reflects the probability as a coefficient of the linear combination does, and thereby allows an experimental simulation of the linear combination. Dissolution under each of the different conditions within a cycle occurs at an approximately same degree of dissolution of an ingredient dissolved (assuming that the ingredient dissolves under each of the different conditions within the cycle at a rate sufficiently low and/or for a duration sufficiently small so that difference in cumulative mass dissolved between any two time points within the cycle may be considered negligible).

The apparatus of the invention comprises new and advantageous dissolution testing cells and dissolution testing apparatuses.

A dissolution testing cell of the invention comprises a cell cavity and at least one opening thereto selected from the group consisting of: (a.) tangential opening, disposed either on a side wall of an axially symmetrical section of the cell cavity or in a peripheral portion of an end wall of the axially symmetrical section, oriented to a given circular direction and in fluid communication with a fluid connection port of the cell; and (b.) ring-shaped opening, disposed on side wall of the cell cavity away from ends thereof and fitted with a ring-shaped filter inner side thereof forming a part of the side wall, and outer side thereof being in fluid communication with a fluid connection port of the cell. These features of construction of the cell, individually or in combination with one another or with other features, advantageously allow the testing of a sample under a more homogenous and/or more controlled hydrodynamic dissolution condition than a cell of the prior art.

A dissolution testing apparatus of the invention comprises: (a.) first pump means driving a stream of dissolution medium at a controlled or programmed flow rate; (b.) second pump means withdrawing a sample from a liquid or driving a sample out of a liquid; (c.) cumulative vessel storing a solute dissolved in a dissolution medium exited from a dissolution testing cell during a dissolution test; (d.) detection means either detecting a solute dissolved in a dissolution medium or providing a sample for the detecting; (e.) first switching valve means switching among at least two positions comprising first position and second position, the first position allowing a sample from the dissolution testing cell to travel to the detection means via a fluid conduit, under aid from either one or both of the first and the second pump means, and the second position a sample from the cumulative vessel; and (f.) control means controlling at least the independent functioning of the first and the second pump means, and the functioning of the first switching valve means. This feature of combination of parts and components in the construction of the apparatus, among other and further features of construction thereof, advantageously allow the determining of a said at least one property as a said advantageous function, among other advantages.

The invention will be more fully understood from the following detailed description, when read in connection with the accompanying drawings.

### BRIEF DESCRIPTION OF THE DRAWINGS

In the drawings:

FIGS. 1A and 1B are plots showing several r(M) functions and r(M,t_{c}) curves, respectively, in a graphic form, determined and evaluated in accordance with a preferred embodiment of the invention;

FIG. 2 is a flow chart highlighting inventive steps of a method of manufacturing in accordance with a preferred embodiment thereof;

FIGS. 3A, 3B, and 3C are, respectively, a top plan view, a bottom plan view, and a front sectional view (taken along line A-A′), of a first dissolution testing cell constructed in accordance with a preferred embodiment of the invention;

FIG. 3D is an interior bottom plan view of the first dissolution testing cell;

FIG. 3E is a front sectional view of a sampling probe therefor;

FIG. 3F is a front sectional view of the first dissolution testing cell with a different bottom filter (34);

FIGS. 4A, 4B, and 4C are, respectively, a bottom plan view, a front sectional view (taken along line B-B′) and a side sectional view (taken along line C-C′), of a second dissolution testing cell constructed in accordance with a preferred embodiment of the invention;

FIGS. 5A, 5B, and 5C are, respectively, a top plan view, a side sectional view (taken along line D-D′), and an exploded side sectional view of a third;

FIG. 5D is a bottom plan view of an upper part of the third;

FIGS. 6A, 6B, and 6C are, respectively, a top plan view, a bottom plan view, and a front sectional view (taken along lines E-E′), of a fourth;

FIG. 7A is a diagram showing fluidics of a first dissolution testing apparatus in use with the first dissolution testing cell in accordance with a preferred embodiment of the invention;

FIG. 7B is a front sectional view of a preferred cumulative vessel;

FIG. 8 is a diagram showing fluidics of a second dissolution testing apparatus in use with the second dissolution testing cell in accordance with a preferred embodiment of the invention;

FIG. 9A is a diagram showing fluidics of a third in use with the third dissolution testing cell;

FIG. 9B illustrates a switching position of a switching valve of the third dissolution testing apparatus, different from a position shown in FIG. 9A;

FIG. 10A is a diagram showing fluidics of a fourth dissolution testing apparatus in use with the fourth dissolution testing cell;

FIG. 10B illustrates an orientation of a rotational cell holder of the fourth dissolution testing apparatus, and FIGS. 10C and 10D switching positions of a switching valve, each different from an orientation or position shown in FIG. 10A.

### DETAILED DESCRIPTION OF THE INVENTION

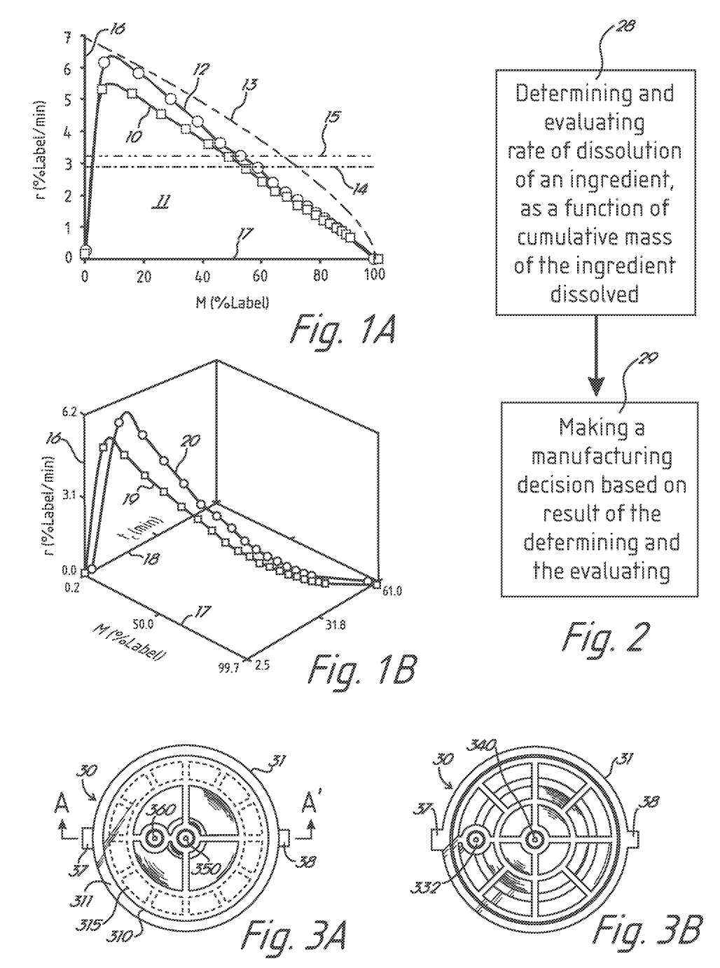

Referring to FIG. 1A, curve 10 is a graphic form of an r(M) function determined and evaluated for a pharmaceutical active ingredient of an immediate release disintegrating pharmaceutical tablet (Kroger Acetaminophen Tablet 500 mg, Lot No. 5EF015) dissolving in a simulated gastric fluid (in the present embodiment, deionized water) under a discrete fluidization and settlement hydrodynamic dissolution condition of an in vitro dissolution process.

Curve 10 is determined and constructed as follows.

First, values of differential rate of dissolution of the active ingredient of the pharmaceutical tablet are experimentally determined at a plurality of points of time in the in vitro dissolution process, each of the values determined under a same hydrodynamic dissolution condition. The condition is described in more detail hereinafter in connection with detailed description of the discrete fluidization and settlement hydrodynamic dissolution condition. The values, determined at the plurality of points of time and under the discrete fluidization and settlement hydrodynamic dissolution condition, numerically express differential rate of dissolution as a function of time of the dissolution process (herein sometimes, “time of dissolution”, or, interchangeably, “dissolution time”). The function is denoted by r(t), where r indicates differential rate of dissolution as the dependent variable of the function and t time of dissolution the independent variable thereof.

Next, values of cumulative mass of the ingredient dissolved are computed from the values of differential rate of dissolution at each of the plurality of points of time by means of numerical integration observing the following integration equation:

$$M ( t ) = {\int }_{0}^{t} r ( t ) \cdot d t \qquad ( 1. )$$

where t denotes the time; M(t) cumulative mass M of the ingredient dissolved at time t; and the remaining symbols either are as defined above or have their ordinary mathematical meanings.

The values of cumulative mass of the ingredient dissolved thus obtained, at the plurality of points of time, numerically express the cumulative mass as a function of time of the dissolution process, i.e., M(t), where the cumulative mass M is the dependent variable and the time of dissolution t the independent variable.

Next, the variable of differential rate of dissolution is expressed as a function of the variable of cumulative mass of the ingredient dissolved by associating the value of the variable of cumulative mass with the value of the variable of differential rate of dissolution (i.e., pairing the latter with the former) at each point of the plurality of points of the common independent variable of dissolution time. The function forms an r(M) function, expressing a determined relationship between the variable of differential rate of dissolution as a dependent variable and the variable of cumulative mass of the ingredient dissolved as an independent variable, for the pharmaceutical active ingredient of the immediate release pharmaceutical tablet dissolving in the simulated gastric fluid in the in vitro dissolution process. Because each of the values of differential rate of dissolution is determined under a same hydrodynamic dissolution condition, i.e., the discrete fluidization and settlement hydrodynamic dissolution condition (described in further detail hereinafter) in the in vitro dissolution process, the r(M) function, in accordance with an advantageous feature of the invention, represents an r(M) function for the ingredient of the solid dosage product dissolving under a given hydrodynamic dissolution condition, i.e., the discrete fluidization and settlement hydrodynamic dissolution condition, in the present embodiment.

Finally, curve 10 is constructed by plotting, in accordance with the determined r(M) function, the variable of r differential rate of dissolution 16, expressed in a unit of mass of the ingredient dissolved per unit time, against the variable of M cumulative mass of the ingredient dissolved 17, expressed in a unit of cumulative mass of the ingredient dissolved. Such a plot (e.g., curve 10) is called a “differential rate-cumulative mass dissolved plot”, or “r(M) plot” (or, r-M plot) in short, sometimes herein.

In the determining of the curve 10 r(M) function, time of contact t_{c} between the acetaminophen tablet and the dissolution medium, is the same as time of dissolution of the experimental dissolution process t, which was time of dissolution under the dissolution condition t_{d} plus three (3) minutes (3 min) of a period of dissolution medium contact time under a static hydrodynamic condition (see experimental details hereinafter). Plotting of r against both M and t_{c} instead of only M provides a three-dimensional (3-D) r(M,t_{c}) curve shown at 19 in a 3-D r-M-t_{c} space in FIG. 1B.

A second curve 12 is shown in FIG. 1A and a corresponding second curve 20 in FIG. 1B. The second curves 12 and 20 are determined on a second acetaminophen tablet from a same lot as the tablet for first curves 10 and 19, in the same manner in which the first curves 10 and 19 are determined, except that the second acetaminophen tablet is exposed to the dissolution medium in a static condition for eight (8) minutes instead of three (3) prior to being subjected to dissolution under a same discrete fluidization and settlement hydrodynamic dissolution condition. Thus, except for the experimental data point at time zero and additional data points determined for curves 10 and 19 towards end of the curves, dissolution medium contact time t_{c} for each experimental data point of the second curves 12 and 20 is five (5) minutes longer than a corresponding experimental data point of the first curves 10 and 19. Envisioning a 3-D r(M,t_{c}) surface passing through the data points and curves, it is seen that the data points and the curves form a part of the 3-D r(M,t_{c}) surface, i.e., an r(M,t_{c}) function plotted in the 3-D r-M-t_{c} space.

While only two curves are determined and shown in each of FIG. 1A and FIG. 1B providing the (r,M,t_{c}) data points, it is understood that additional such curves may be determined, constructed, and included, using additional dissolution processes (of replicates of the solid dosage sample) one for each of the curves, to provide additional data points for the r(M,t_{c}) function.

Further, an (r,M,t_{c}) data point for an r(M,t_{c}) function may be determined in any manner including independently one point from another regardless of an r(M,t_{c}) curve. Likewise independently, an (r,M) data point for an r(M) function.

Referring to curve 10 in FIG. 1A, the r(M) function (curve 10) is used to advantageously provide fine monitoring of rate of dissolution of different portions of the active ingredient of the acetaminophen tablet under a given dissolution condition (i.e., presently the discrete fluidization and settlement hydrodynamic condition). Curve 10 shows that rate of an initial portion of acetaminophen of the tablet, at 0% label dissolved, is very low. The rate rapidly increases to a peak of about 5.3% label/min at about 5% label dissolved. Thereafter the rate decreases almost linearly as the active ingredient progressively dissolves from the tablet, until complete dissolution (i.e., 100% dissolved, taking into consideration of content deviation from label amount). Such a feature of fine monitoring is used in fine-tuning and control of formulation and manufacturing process variables, to achieve desired rate performance of dissolution of an ingredient of a solid dosage product. The feature is especially useful when a product contains different portions of an active ingredient that are intended to be released at different rates (e.g., a controlled release pharmaceutical tablet that contains a fast release loading dose and a slow release maintenance dose, data not shown).

Referring to FIG. 1A, a comparison of differential rate of dissolution of acetaminophen from the two tablets is made on a mass by mass basis, at same degrees of dissolution of acetaminophen from the two tablets. More specifically, for example, at 0% label of the active dissolved, both tablets are seen to show a very low dissolution rate of the active. At about 20% label dissolved, the tablet that had an extra five minutes of contact with dissolution medium (at each experimental data point) is seen to show a dissolution rate (curve 12) almost 1% label/minute higher than the other (curve 10). Difference in dissolution rates between the two tablets are seen to gradually decrease as the active ingredient gradually dissolves, to values very small after about 50% label of the active was dissolved (FIG. 1A).

The very low dissolution rates of the active ingredient at 0% label dissolved was used to infer a very small surface area of the acetaminophen active exposed to dissolution medium for both tablets when intact. The higher rate of the curve 12 tablet at 20% label dissolved (FIG. 1A) was used to infer a higher degree of exposure of its active to the dissolution medium, which may have resulted from a higher degree of disintegration of the tablet, or further disintegration of granules thereof. The higher degree of disintegration, in turn, may have been a result of the tablet's extra contact time with the dissolution medium. The gradual decrease in difference in rates between the two tablets after 50% label of the active dissolved was used to infer a diminishing role of the disintegration in influencing the degree of exposure of the active to the dissolution medium, which may be the case at late stages of the dissolution process, when the disintegration reached toward completion.

Referring to curves 10 and 12 in FIG. 1A again, as dissolution rate of the immediate release disintegrating acetaminophen tablet product has some dependency on dissolution medium contact time t_{c} during early stages of a dissolution process before disintegration is complete, curves 10 and 12 do not completely overlap.

When a dissolution rate is substantially independent of t_{c}, as may be the case for certain non-disintegrating controlled release beads under given dissolution conditions, and for completely disintegrated granules of certain immediate release solid dosage forms, r(M) functions will show substantial overlap regardless of differences in t_{c}.

On the other hand, when a dissolution rate is substantially influenced by t_{c}, as may be the case for certain polymer-coated pharmaceutical tablets and in early stage of a dissolution process of an immediate release disintegrating tablet, r(M) functions that differ in t_{c} between data points of a same M will show gaps in between.

In FIG. 1A, the linear behavior of the portion of the curve 10 r(M) function in the mass range after 10% label or so dissolved was surprising as, initially, it was thought that the function might behave in a curved manner over the mass range, as a theoretically constructed r(M) function had suggested when a certain theoretical model of dissolution known in literature was assumed. In FIG. 1A, shown in broken line illustration 13 is a theoretical r(M) function constructed on assumption that dissolution of disintegrated granules of a tablet follows a so-called Hixson-Crowell model (Hixson, A and Crowell, J, 1931, Ind. Engg. Chem. 23:923-931), which in turn assumes a Noyes-Whitney theory (Noyes, A A and Whitney, W R, 1897, J. Am. Chem. Soc., 19:930-934). The clear deviation of both of the determined curves 10 and 12 from the theoretically constructed function 13 shows that a Hixson-Crowell model does not accurately account for dissolution behavior of the acetaminophen tablets tested under the discrete fluidization and settlement hydrodynamic dissolution condition.

The linear portion of the curve 10 (FIG. 1A), rather, suggests a behavior of first-order like kinetics. The behavior of first-order like kinetics allows the linear portion to be described analytically by a linear equation obtained by linear regression of the portion of the experimentally determined r(M) data 10. Slope of a linear regression line gives a first-order kinetic constant k. For curve 10, k was determined from the slope at 0.060 min⁻¹, and for curve 12, 0.071 min⁻¹ Such a method of the determining of kinetic order and kinetic constants (parameters) from shape and parameters of an empirically determined r(M) function, and method of the empirically determining of (r,M) data and mathematically fitting of an analytical expression to the empirically determined (r,M) data (e.g., r=6−0.06×M , fitted to the linear portion of curve 10), are features of the invention. The term “empirically”, as used herein, denotes “as directly observed, rather than on basis of, i.e., without having to assume, a theory or model (e.g., Hixson-Crowell, first-order, or zero-order kinetic model)”.

While the immediate release, disintegrating acetaminophen tablets tested in the FIG. 1A embodiment of the invention, under the discrete fluidization and settlement hydrodynamic dissolution condition (further disclosure hereinafter), show apparent linear behaviors (curves 10 and 12, FIG. 1A), it is to be understood that the shape of an r(M) function determined under a given dissolution condition or for a given dissolution process may vary widely depending on physical structure and dissolution mechanism of a dissolving solid dosage product, and depending on the given dissolution condition (including any effect from dissolution medium contact time t_{c}) or the given dissolution process (including time-function of dissolution condition thereof). Determined under a given a dissolution condition (including t_{c} where t_{c} has an effect on r) in accordance with a preferred embodiment of the invention, the shape of an r(M) function may be used to provide an insight into the physical structure and dissolution mechanism of a solid dosage product, and a guidance to, or a control of, the manufacturing of same.

An example of guidance to or control of the manufacturing is the use of an r(M) function determined under a given in vitro dissolution condition (including t, where r is dependent on t_{c}) to monitor deviation if any of a solid dosage product within a production batch, and from one batch to another, material and process being maintained, adjusted, and/or halted in a process of the manufacturing, where necessary to confine the r(M) function to a target range both in shape of the r(M) function and in value of dissolution rates (see also computation of mean differential rate of dissolution over mass in further disclosure of the invention hereinafter). In a case of pharmaceutical product, an r(M) function determined under a given in vitro dissolution condition for a clinically successful trial batch may be used as a target towards which scale-up developments, formulation and process modifications including site changes, and product line extension developments may be guided. The target may also comprise quality control specification ranges established from r(M) functions of additional clinically successful trial batches, from knowledge of products similar in particulate physical attributes (more particularly, transit properties), and/or from in vivo dissolution rate modeling and simulation studies (see further disclosure hereinafter).

For such use as a guidance, an r(M) function does not need to be determined under a complex in vitro dissolution condition that exactly reproduces a time- and space-varying, i.e., complex, in vivo dissolution condition. Rather, an r(M) function is preferably determined under a substantially simpler and easily controlled homogenous in vitro dissolution condition that simulates a component dissolution condition of a complex in vivo dissolution process. The in vitro dissolution condition is such that each dissolving particulate of a sample under testing, or those thereof having a same vertical velocity of fluidization, are subjected to a same dissolution medium and a statistically substantially (e.g., with a >95% probability) same experience in both velocity and duration of local dissolution medium flow (i.e., same average hydrodynamic dissolution condition) (herein sometimes, “pseudo-homogenous dissolution condition”), in the determining of each and every data point of the r(M) function. The term “homogenous dissolution condition”, as used herein in a broader sense, thus embraces the term “pseudo-homogenous dissolution condition” (in a narrow sense, it denotes identical dissolution condition at a given point of time at all surface of a dissolving solid exposed to dissolution medium). For many oral solid dosage pharmaceutical products that dissolve following a pH- and surfactant-independent dissolution mechanism, an in vitro dissolution medium needs only to be aqueous based, and an r(M) function determined in the aqueous in vitro dissolution medium is linearly related to an r(M) function of the solid dosage product dissolving in another aqueous dissolution medium of a different pH, surfactant concentration, and/or temperature, under a given common hydrodynamic dissolution condition. Where the dissolution mechanism is dependent on pH and/or surfactant, e.g., in a case of disintegrating immediate release pharmaceutical tablet the disintegration of which is pH- and/or surfactant-dependant, an in vitro dissolution medium of time-programmed, varying pH and/or surfactant composition may be used in the determining of the r(M) function.

An r(M) function determined under an in vitro dissolution condition in such a manner does not provide an in vitro dissolution rate function that directly reproduces or mimics an exact in vivo rate function for an in vivo dissolution process (for computational and direct experimental simulations of an in vivo rate function, see further disclosure hereinafter). Rather, the r(M) function is intended to provide a detailed characterization of rate of dissolution of an ingredient of a solid dosage product, as the dissolution occurs under a given dissolution condition, and at various degrees of dissolution of the ingredient (with M as a metric of degree of dissolution).

Replicate determinations of an r(M) function of a solid dosage product, obtained on replicate units of the solid dosage product under an identical dissolution condition (including t_{c} if r depends on t_{c}), are mathematically or statistically averaged, and a metric of variability of an average, e.g., variance thereof, computed, for rate of dissolution r at each value of M. The average and variance provides a measure of statistical distribution of rate of dissolution of an ingredient of the solid dosage product at each degree M of dissolution of the ingredient, under the identical dissolution condition. This is essentially measurement of a product variability, and is in contrast to the traditional teaching of statistical averaging, and computation of variance, of replicate determinations of an M(t) or r(t) function. The traditional teaching pertains to a dissolution process (as t is a process variable) and any computation of variance according to the traditional teaching relates to (variance of) the dissolution process, bearing no simple and direct relationship with product variability. Because r can be extremely, and M cumulatively, t-sensitive, variance computed in accordance with the traditional teaching in the time domain may be high at certain time points of a dissolution process, in either of the cases especially the case of r, but the variability is not necessarily a true and useful indication of the variability of a dissolving solid dosage product.

To reduce the variability of dissolution of a solid dosage product in vivo in accordance with a preferred embodiment of the invention, formulation and manufacturing process variables for the solid dosage product are controlled to the effect of a reduced variability in replicate determinations of an r(M) function in vitro (under a same dissolution condition including dissolution medium contact time, and, for even better product quality, i.e., more reduced dissolution variability, under certain different hydrodynamic dissolution conditions and dissolution medium contact times). Such controlling involves, e.g., the limiting of a solid matrix structure, drug release mechanism, and formulation to a certain design, the limiting of physical and physicochemical properties (e.g., particle size distribution, grade, vertical velocity of fluidization, hydraulic conductivity, porosity, water content, hydrate and crystal forms etc.) of a raw material (active and excipients) to a certain range, the adjusting of the properties, amount, and composition of a raw material, and the changing of process parameters such as water content, tableting pressure, and blending time, etc.

An r(M) function is used to provide an absolute measurement of rate of dissolution of an ingredient of a solid dosage product under a given dissolution condition (including t_{c} where r depends on t_{c}), and to rank the solid dosage product in a cross-product or cross-ingredient dissolution rate ranking system. An r(M) function determined for one solid dosage product is directly compared with an r(M) function determined for another.

The term “determining”, as used herein in the present patent document, is a short form of the term “experimentally determining”, which, in either of its short or full form as used herein, denotes “obtaining of value of (a metric, e.g., differential rate of dissolution of a solid dosage product), by way of an experimental procedure or by way of a procedure comprising at least an experimental step”.

The term “evaluating”, as used herein, denotes “finding of value of', or, “appraising of value of'. When the term is used herein in a context of the appraising of value of a metric (e.g., differential rate of dissolution of an ingredient as a function of cumulative mass of the ingredient dissolved) on a pharmaceutical product in the manufacturing quality control thereof, the appraising may include the comparing of value of the metric (e.g., the differential rate as the function of cumulative mass of the ingredient dissolved) with a standard, or a quality control specification, either directly on the value (of the metric, e.g., the differential rate as the function of cumulative mass of the ingredient dissolved), or, after a mathematical manipulation of the value (or the function), on result of the mathematical manipulation. The mathematical manipulation may comprise a step selected from the group consisting of: (a.) transformation (e.g., linear) of the value (or the function) to value of an equivalent measure (of the metric, e.g., the differential rate, or an equivalent function); (b.) averaging, including linear combination, of the value with a value or values of a same measure obtained under, or for, a same or another or other experimental conditions (e.g., value of the differential rate obtained at the given degree of dissolution under another given dissolution condition); and (c.) computational modeling, of either the value (or the function) directly or result of a mathematical manipulation of the value (or the function), for an output of simulated in vivo pharmacokinetic or pharmacodynamic performance. The appraising may also include, alternatively or additionally, the comparing of value of an underlying factor that contributes to value of the metric and that has a known or validated physical relationship therewith, with a standard or specification on the value of the underlying factor, established from the standard or specification on the value of the metric, based on the known or validated physical relationship therewith. In such a case, the term “determining”, when used herein together with the term “evaluating”, with reference to the metric, also embraces, in scope of meaning, the determining of the value of the underlying factor that has the known or validated physical relationship with the value of the metric.

The term “as a function of (e.g., cumulative mass dissolved)”, as used herein, denotes “as a dependent variable the value of which is treated as dependent on value of one or more independent variables and co-independent variables that consist of (e.g., the cumulative mass dissolved)”. When the term is used herein together with any of the terms “determining”, “determined”, “evaluating”, “evaluated”, “controlling”, and “controlled”, the word “function” in the term implies a quantitative mathematical function as expressed in a form (e.g., graphical, numerical, or analytical), the quantitative mathematical function having value at each of a plurality of at least three, preferably at least five given points of value of at least one of said one or more independent variables and co-independent variables. When used herein together with any of the terms “empirically determining” and “empirically determined”, the any of the terms “empirically determining” and “empirically determined” refers to value of the quantitative mathematical function at the each of a plurality of at least three, preferably at least five given points of value.

The term “differential rate of dissolution”, when used herein in a narrow sense as indicated by a reference in a context to the following equation (2.) or symbol dM/dt, denotes a property mathematically defined as:

$$r = \frac{d M}{d t} \qquad ( 2. )$$

where r denotes differential rate of dissolution, and dM/dt first derivative of an M(t) function, the M(t) function expressing cumulative mass M of an ingredient dissolved from a sample of a solid dosage product in a dissolution process as a function of time t thereof.

The term “mean differential rate of dissolution over time”, or its short form “mean differential rate over time”, when used herein in a narrow sense as indicated by a reference in a context to the following equation (3.) or symbol ΔM/Δt, denotes a property mathematically defined as:

$${\overline{r}}_{time} = \frac{Δ M}{Δ t} \qquad ( 3. )$$

where r̅ₜᵢₘₑ denotes mean differential rate of dissolution over time, ΔM a range of mass of an ingredient dissolved from a sample of a solid dosage product, and Δt a range of time taken to dissolve the range of mass ΔM.

The term “differential time of dissolution”, when used herein in a narrow sense as indicated by a reference in a context to the following equation (4.) or symbol dt/dM, denotes a property mathematically defined as:

$$τ = \frac{d t}{d M} \qquad ( 4. )$$

where τ denotes differential time of dissolution, and dt/dM first derivative of a t(M) function, the t(M) function expressing cumulative amount of time t taken to dissolve cumulative mass M of an ingredient of a sample of a solid dosage product in a dissolution process.

The term “mean differential time of dissolution”, or its short form “mean differential time”, when used herein in a narrow sense as indicated by a reference in a context to the following equation (5.) or symbol Δt/ΔM, denotes a property mathematically defined as:

$${τ}_{mean } = \frac{Δ t}{Δ M} \qquad ( 5. )$$

where τₘₑₐₙ denotes mean differential time of dissolution, ΔM a range of mass of an ingredient dissolved from a sample of a solid dosage product, and Δt a range of time taken to dissolve the range of mass ΔM.

When used herein in a broad sense, i.e., without specifically referring to equation (2.) or the symbol dM/dt in a context, the term “differential rate of dissolution” partially embraces, in scope of meaning, the term “mean differential rate of dissolution over time”, denoting a property defined by either equation (2.) or equation (3.) wherein Δt is sufficiently small to allow ΔM/Δt to be a close approximation of dM/dt.

When used herein in a broad sense, i.e., without specifically referring to equation (4.) or the symbol dt/dM in a context, the term “differential time of dissolution” partially embraces, in scope of meaning, the term “mean differential time of dissolution”, denoting a property defined by either equation (4.) or equation (5.) wherein Δt is sufficiently small to allow Δt/ΔM to be a close approximation of dt/dM.

The term “cumulative mass of an ingredient dissolved from a sample of a solid dosage product”, as used herein, denotes total amount of an ingredient dissolved from a sample of a solid dosage product e.g. cumulatively by a point of time in a dissolution process. The term is sometimes shortened to “cumulative mass dissolved” or “cumulative mass” herein.

The term “rate of dissolution”, as used herein, is a short form of the term “differential rate of dissolution”, and expressly excludes, in scope of meaning, the term “cumulative mass of an ingredient dissolved”, as the short form sometimes embraces in language of teaching in prior art.

The symbol AUrMC, as used herein, represents an abbreviation of the term “area under the curve of an r(M) function”, and is interchangeable therewith herein, denoting a property mathematically defined by the following equation:

$$AUrMC = {\int }_{A}^{B} r ( M ) \cdot d M \qquad ( 6. )$$

where AUrMC denotes area (e.g., 11, FIG. 1A) under the curve for a segment of a curve of an r(M) function (e.g., 10), between two points A and B (e.g., for area 11, A=0% label, B=100% label) on a horizontal axis of cumulative mass dissolved (in the FIG. 1A embodiment, cumulative fraction dissolved, 17); r(M) denotes the r(M) function describing the curve; and the remaining symbols have their ordinary mathematical meanings. AUrMC is a said advantageous form of properties of dissolution taught herein.

The term “mean differential rate of dissolution over mass”, and its short form “mean differential rate over mass”, as used interchangeably herein, each denote a property mathematically defined by the following equation:

$${\overline{r}}_{ma ss} = \frac{AUrMC}{B - A } \qquad ( 7. )$$

where r̅ₘₐₛₛ denotes mean differential rate over mass for a given portion (i.e., the portion from A to B) of mass of an ingredient of a sample of a solid dosage product dissolving in a given dissolution process or under a given dissolution condition; and the remaining symbols have same meanings as in equation (6.) for the ingredient dissolving in the given dissolution process or under the given dissolution condition. Mean differential rate over mass is a said advantageous form of properties of dissolution taught herein.

The term “mean dissolution time”, as used herein, denotes a property mathematically defined by the following equation:

$$\begin{matrix}{\overline{t}}_{mass} = \frac{1}{{\overline{r}}_{mass}} \\ = \frac{B - A}{AUrMC}\end{matrix} \qquad ( 8. )$$

where t̅ₘₐₛₛ denotes mean dissolution time, for a given portion (i.e., the portion from A to B) of mass of an ingredient of a sample of a solid dosage product dissolving in a given dissolution process or under a given dissolution condition; and the remaining symbols have same meanings as in equation (6.) and equation (7.) for the ingredient dissolving in the given dissolution process or under the given dissolution condition. Mean dissolution time is a said advantageous form of properties of dissolution taught herein.

In certain preferred embodiments of the invention, there is included a step of determining a member selected from the group consisting of AUrMC, mean differential rate over mass, and mean dissolution time, each as a useful measure of mean rate of dissolution of an ingredient of a solid dosage product dissolving in a dissolution process or under a certain dissolution condition (of, e.g., a dissolution process). In an equivalent manner, area under an r(M,t_{c}) curve over given M and co-varying t_{c} values, volume under the surface of differential rate of dissolution over a region of continuous value of two or more independent variables comprising cumulative mass dissolved, and mean value of the differential rate, are determined and evaluated, or controlled, in certain embodiments of the invention, as a useful measure of mean value of the differential rate over given values of the independent variables. The computation of a mean value of a dependent variable over given continuous values of one or more independent variables is an extension of the computation of an arithmetic mean of the dependent variable over given discrete values of the independent variables. Both computations pertain to a mean value of the dependent variable over given (continuous or discrete) values of the independent variables.

Other properties of dissolution (e.g., vertical velocity of fluidization) are similarly determined and evaluated, or controlled, as a mean value over given values of, at least, the cumulative mass dissolved. In a preferred embodiment of the invention, values of a property of dissolution (e.g., differential rate of dissolution) at a given value of a measure of cumulative mass dissolved and different values of other independent variables (e.g., dissolution medium contact time and hydrodynamic and physicochemical dissolution conditions) are, first, averaged by weighted average over variation of the other variable or variables to provide an average value of the property at the given value of the measure of cumulative mass. A mean value of the average value of the property is then computed over given values (continuous or discrete) of the measure of cumulative mass. For weighted average, see, e.g., further detailed description of linear combination of differential rates hereinafter at, e.g., equation (14.).

In FIG. 1A, for example, mean differential rate over mass for the first 50% of the labeled mass of the active ingredient of the tablet of curve 10 is computed according to equation (7.) at 4.2% label/min (4.2% label per minute), and mean dissolution time, computed according to equation (8.), at 0.24 min/% label (0.24 minutes per 1% label). For the tablet of curve 12, mean differential rate over mass for the first 50% of the labeled mass is 4.7% label/min and mean dissolution time 0.21 min/% label. Over a full range of the labeled mass (0% to 100% label), mean differential rate for the tablet of curve 10 is 2.9% label/min (indicated by broken line 14 in FIG. 1A) and mean dissolution time 0.35 min/% label, compared to mean differential rate 3.3% label/min (15, FIG. 1A) and mean dissolution time 0.31 min/% label, of curve 12.

In accordance with the computation of mean differential rate over mass and mean dissolution time, in the curve 10 embodiment of the invention, it may be said that the first 50% of the labeled mass of the active ingredient of the pharmaceutical tablet dissolves at an average rate of 4.2% label per minute, and it would take 50% label×0.24 min/% label=12.0 minutes for the first 50% of the labeled mass to completely dissolve under the given (discrete fluidization and settlement hydrodynamic) dissolution condition. In comparison, in the curve 12 embodiment, the average rate is 4.7% label per minute and it would take 10.5 minutes for the first 50% to dissolve under the given dissolution condition differeing, however, in dissolution medium contact times. The slightly higher rates and less time to dissolve seen in curve 12 was interpreted as a result of an increased surface area of the dissolving ingredient exposed to dissolution medium due to a higher extent of disintegration as a result of the extra five minutes of dissolution medium contact time before dissolution under the discrete fluidization and settlement hydrodynamic dissolution condition. Similarly, it may be said that, over a full range of the labeled mass (0% to 100% label), the active ingredient of the tablet of curve 10 dissolves at an average rate of 2.9% label per minute under the given dissolution condition, and it would take 35 minutes for the full range of the labeled mass to dissolve (if all) under the given dissolution condition, compared to an average rate of 3.3% label per minute and 31 minutes to dissolve, of curve 12 under the same hydrodynamic condition and different dissolution medium contact times.

An AUrMC may be computed in accordance with a preferred embodiment of the invention from an r(M) function (e.g., curve 10) in mass domain by way of the observing of equation (6.).

An AUrMC may also be computed in accordance with another embodiment of the invention, from an r(t) function in time domain by way of observing the following equation:

$$AUrMC = {\int }_{{t}_{A}}^{{t}_{B}} {[ r ( t ) ]}^{2} \cdot d t \qquad ( 9. )$$

where t denotes time; t_{A} denotes value of the time, t, when cumulative mass dissolved, M, is at value of A; t_{B} denotes value of the time, t, when cumulative mass dissolved, M, is at value of B; [r(t)]² denotes square of r(t); and the remaining symbols have same meanings as in equations (1.), (6.) and (7.).

Equation (9.) is derived from equation (6.) by replacing of variable and combining with a rearranged form of equation (2.) wherein r is given the form of r(t).

In an embodiment of the invention involving the computing of AUrMC over a cumulative mass dissolved range ending at a point of complete (i.e., 100%) dissolution, a skilled artisan taught by the present disclosure will prefer the use of equation (6.) over equation (9.), because typically an r(M) function rapidly approaches zero as M approaches 100% dissolved but an r(t) function becomes asymptotic as t increases towards infinite.

In the FIG. 1A embodiments of the invention, the variable of cumulative mass dissolved, M (axis 17), is expressed in a unit of “% label”, i.e., percent of the total labeled mass of the active ingredient of the pharmaceutical tablet. Correspondingly, the variable of differential rate of dissolution, r (axis 16), is expressed in a unit of “% label/min”, i.e., percent of the total labeled mass per minute.

When the variable of cumulative mass dissolved is expressed in such a unit of percent, or fraction, of a given total mass, an r(M) function may also be called an “r(F) function”, or “an r(M) function in an r(F) form” (F stands for fraction which in scope of meaning embraces percent), herein.

In comparison, the term “an r(M) function in an r(M) form”, as used herein, denotes specifically an r(M) function in which M is expressed in an absolute mass unit (e.g., milligrams or micrograms).

A useful feature of an r(M) function in an r(M) form determined and evaluated in a preferred embodiment of the invention is scalability among compositionally identical fractions of a solid dosage product:

$$\begin{matrix}{r}_{j} ( {M}_{j} ) = {f}_{j} \cdot r ( \frac{{M}_{j}}{{f}_{j}} ) \\ = {f}_{j} \cdot r ( M )\end{matrix} \qquad ( 10. )$$

where rⱼ(Mⱼ) denotes differential rate of dissolution, in absolute mass dissolved per unit time, of an ingredient of a j-th compositionally identical fraction of a solid dosage product under a given dissolution condition at a point of Mⱼ of absolute mass of the ingredient cumulatively dissolved from the fraction; fⱼ a fractional number for the j-th compositionally identical fraction, defined as ratio, wⱼ/w₀, of initial mass of the ingredient of the fraction, wⱼ, over initial mass of the ingredient of the whole product, w₀; and r(M) differential rate of dissolution of absolute mass of the ingredient of the whole solid dosage product under the given dissolution condition at a point of M=Mⱼ/fⱼ of absolute mass of the ingredient cumulatively dissolved from the whole solid dosage product.

A useful feature of an r(F) function determined and evaluated in a preferred embodiment of the invention is equality among compositionally identical fractions of a solid dosage product when both differential and cumulative masses dissolved refer to a fraction, e.g., percent, of mass of an ingredient of a respective member of said compositionally identical fractions, for example:

rⱼ(Fⱼ)=r(F) (11.)

where rⱼ(Fⱼ) denotes differential rate of dissolution, in percent of mass dissolved per unit time, of an ingredient of a j-th compositionally identical fraction of a solid dosage product under a given dissolution condition at a point of Fⱼ percent of mass of the ingredient of the fraction cumulatively dissolved therefrom; and r(F) differential rate of dissolution of percent of mass of the ingredient of the whole solid dosage product under the given dissolution condition at a point of F percent of mass of the ingredient of the whole solid dosage product cumulatively dissolved therefrom.

An M(t) function for a given dissolution process is obtained analytically or numerically from its inverse function t(M). The t(M) function in turn is obtained from an r(M) function determined for the given dissolution process in a preferred embodiment of the invention, by way of observing the following equation:

$$\begin{matrix}t ( M ) = {\int }_{0}^{M} τ \cdot d M \\ = {\int }_{0}^{M} \frac{d M}{r ( M )}\end{matrix} \qquad ( 12. )$$

where symbols are either as defined in equation (4.) and above or have their ordinary mathematical meanings.

An M(t) function for a given dissolution process is also obtained from an r(M) function determined for the given dissolution process in a preferred embodiment of the invention numerically by way of stepwise application of the following finite difference equations starting from an initial condition of, e.g., i=0, tᵢ=0, and Mᵢ=0:

tᵢ₊ᵢ=tᵢ+Δtᵢ and Mᵢ₊₁=Mᵢ+r(Mᵢ)·Δtᵢ (13.)

where subscript i denotes a sequential step number, which is an integer selected from an integer series starting from zero; tᵢ, Mᵢ, r(Mᵢ) and Δtᵢ time of dissolution, cumulative mass dissolved, differential rate of dissolution and step size, respectively, at a step of sequential step number i; and subscript i+1 sequential step number of a next step. Other numerical methods of the solving of differential equations, such as the Runge-Kutta methods (Perry's Chemical Engineer's Handbook, Sixth ed., page 2-68, McGraw-Hill), for obtaining the M(t) function from the r(M) will be apparent to those skilled in the art and mathematics, taught by the present disclosure.

Replacing the independent variable (i.e., M) of an r(M) function determined for a given dissolution process, with M(t) after computation thereof by way of observing either equation (12.) or (13.), provides an r(t) function for the given dissolution process in a preferred embodiment of the invention.

The term “particulate member”, as used herein, denotes a small sized, solid or gel-like structure of a material, e.g., particles and granules of a disintegrated pharmaceutical tablet, and the tablet. The term may sometimes be shortened to the short form “particulate” herein.

The term “solid dosage product”, as used herein, denotes a dosage product that comprises at least one particulate member, the particulate member containing an amount of an ingredient soluble in a dissolution medium, or that can be released from a solid-bound or encapsulated form to the dissolution medium. Examples of solid dosage products include tablets, capsules, sustained release beads, liquid suspensions of particulates, inhalable powders, stents, solid implants, transdermal patches containing particulates, creams, among others.

The term “a sample of a solid dosage product”, as used herein, denotes a representative dosing unit of a solid dosage product, a plurality of representative dosing units thereof, a fraction of a representative dosing unit (e.g., a portion of granules of a disintegrated tablet), a subpart thereof (e.g., granules of a capsule without hard gelatin shell of the capsule), or an intermediate product of production thereof (e.g., granules of a tablet prior to tableting). The term is not limited to a physical sample but in scope of meaning embraces any collection of physical samples of a solid dosage product that collectively provide the data needed for the construction of, e.g., an r(M) function of the solid dosage product.

The term “solid”, as used herein, when context of use suggests the use as an adjective, denotes comprising a particulate or having the property of a particulate. When context of use suggests a noun, the term denotes a particulate or a plurality of particulates.

The term “dissolution environment”, as used herein, denotes a space filled with a liquid, i.e., a dissolution medium, in which a solid dissolves.

The term “dissolution process”, as used herein, denotes an event of dissolution of a solid in a dissolution medium in a dissolution environment, over a duration of (dissolution) time.

The term “dissolution condition”, as used herein, denotes a collective combination of fluid mechanical and/or physicochemical characteristics of a dissolution medium in a dissolution environment, or of a dissolution process. When dissolution medium contact time affects rate of dissolution by way of, e.g., disintegration or dissolution of a coating of a tablet changing exposed surface area of a dissolving ingredient and/or other properties of dissolution, the term “dissolution condition”, as used herein, may also denote the dissolution medium contact time.

A combination of fluid mechanical characteristics of a dissolution medium in a dissolution environment or of a dissolution process may sometimes be called a “hydrodynamic dissolution condition” of the dissolution environment or process, or, in short, “hydrodynamic condition” thereof, herein.

A combination of physicochemical characteristics of a dissolution medium in a dissolution environment or of a dissolution process may sometimes be called a “physicochemical dissolution condition” of the dissolution environment or process, or in short, “physicochemical condition” thereof, herein.

A hydrodynamic dissolution condition may be described in terms of fluid flow velocity and direction, or pressure gradient of the fluid, as variables of the hydrodynamic dissolution condition, among other variables.

A physicochemical dissolution condition may be described in terms of chemical composition of the dissolution medium, pH thereof, temperature thereof, density thereof, and viscosity thereof, as variables of the physicochemical dissolution condition, among other variables.

A dissolution environment and the dissolution condition thereof may be said to be “complex” if value of a variable of the dissolution condition is space-dependent (i.e. varies from one point or region of space to another at any given point of time), time-dependent (i.e. varies from one point or period of time to another at any given point of space), or may be described by a probability function (i.e., varies at a probability, given the time and the space).

A dissolution process and the dissolution condition thereof may be said to be “complex” if a variable of the dissolution condition excepting the variable of dissolution medium contact time, with regard to a given dissolving solid or any portion thereof, is time-dependent or described by a probability function.

The dissolution environment, process and conditions may be said to be “simple” if variables of the conditions are time- and space-independent. In between complex and simple, the dissolution environment, process and conditions may be said to be “simpler”.

A dissolution process and the dissolution condition thereof are generally considered to be “complex” when the dissolution process involves heterogeneous dissolution, defined as the dissolution of different particulates of a dissolving solid, and/or different areas of the surface of a dissolving ingredient, occurring under different dissolution conditions at a given point of time. The dissolution condition, at any given point of time, may be described by a probability function expressed in a form of the percentage of the particulates, or the percentage of the surface area, dissolving under each of a plurality of component dissolution conditions.

The term “in vivo”, as used herein, denotes in or of an original setting, especially a biological or natural environmental setting, such as the intralumen (lumenal) environmental setting of the GI tract of a live human.

The term “in vitro”, as used herein, denotes in, or of, an artificially constructed and experimentally simulative setting, such as a laboratory dissolution test setting in a laboratory dissolution testing apparatus.

A dissolution condition may be said to be a “component dissolution condition” of a dissolution process if the dissolution condition has a probability to be found in the dissolution process, i.e., at a given point of time thereof, or as averaged over a given short period thereof, with regard to a given local dissolution environment (of e.g. a given particulate or plurality of particulates of the dissolution process). In said short period, the effect of change in degree of dissolution on rate of dissolution is negligible. Likewise, a simpler dissolution condition (e.g. a component dissolution condition of a complex dissolution process) may be said to be a “component dissolution condition” of a more complex dissolution condition (e.g., that of the complex dissolution process).

In the evaluating of rate of dissolution of an ingredient of a solid dosage product or a sample thereof dissolving in a complex (e.g., time-dependent and heterogeneous) dissolution process, a preferred embodiment of the invention comprises a step of evaluating an r(M,t_{c}) function for the ingredient dissolving under each of a plurality of in vitro (e.g., substantially homogenous, with regard to, e.g., particulates having a given vertical velocity of fluidization) dissolution conditions, each member of the plurality of in vitro dissolution conditions simulating a component dissolution condition of the in vivo dissolution process. The preferred embodiment teaches an inventive use of an equation of the following general form, for the modeling or simulating of differential rate of dissolution of a complex (e.g., time-dependent and heterogeneous) in vivo dissolution process, linearly with differential rates of dissolution of a sample of a solid dosage product determined or determinable under an in vitro (e.g., the substantially homogenous) dissolution condition:

$$R ( M , t ) = {\sum }_{i = 1}^{n} {η}_{i} \cdot {r}_{i} ( M , {t}_{c} , {t}_{i} ) + ɛ \qquad ( 14. )$$

where R(M,t) denotes differential rate of dissolution of an ingredient of a solid dosage product or a sample thereof dissolving in a complex dissolution process, at a point of time t thereof, when cumulative mass of the ingredient dissolved from the solid dosage product or the sample thereof is M; i an integer representing a membership number of an i-th member of a plurality of n component dissolution conditions (physicochemical and hydrodynamic) of the complex dissolution process, n being an integer 1 (greater than or equal to one); rᵢ(M,t_{c},tᵢ) differential rate of dissolution of the ingredient dissolving from the solid dosage product or the sample thereof under an in vitro dissolution condition simulating an i-th member of the plurality of n component dissolution conditions, the solid dosage product or the sample thereof having a cumulative mass, M, of the ingredient dissolved therefrom and had a dissolution medium contact time t_{c} effectively equal to t (while time for the ingredient to reach the cumulative mass dissolved Min an in vitro dissolution process being tᵢ, if dissolution condition of the in vitro process were to consist of only the i-th in vitro simulative dissolution condition); a linear modeling coefficient for rᵢ(M,t_{c},tᵢ); ε an error term; and the remaining symbols have their ordinary mathematical meanings. Equation (14.) is hereinafter sometimes referred to as a “general form of linear modeling equation” of method of the present invention (the term “modeling” in this context embraces the term “simulating” in scope of meaning).

Consider a simple case of the dissolution of a single particulate of a solid dosage product in a complex in vivo dissolution process in the GI tract of a live human. Let R(M,t) denote differential rate of dissolution of an ingredient dissolving from the particulate at a point of time t of the complex in vivo dissolution process, when cumulative mass of the ingredient dissolved from the particulate is M. Let i denote an integer representing a membership number of an i-th member of a plurality of n component dissolution conditions (physicochemical and hydrodynamic) that may be found in the complex in vivo dissolution process, n being an integer ≧1. At the point of time t, the particulate is located at a point of space (or location) z in the GI tract, z being generally a function oft, representing a transit function z(t) for the particulate in the GI tract. Let pᵢ(z) denote a percent probability of finding an i-th member of the plurality of n component dissolution conditions at the point of space z (and time t). Let rᵢ(M,t_{c},tᵢ) denote differential rate of dissolution of the ingredient dissolving from the particulate under an in vitro dissolution condition simulating an i-th member of the plurality of n component dissolution conditions, the particulate having had a cumulative mass, M, of the ingredient dissolved therefrom and a dissolution medium contact time t_{c} effectively equal to t (while time for the ingredient to reach the cumulative mass dissolved M in an in vitro dissolution process being tᵢ, if dissolution condition of the in vitro process were to consist of only the i-th in vitro simulative dissolution condition). The following equation is written and used in accordance with a preferred embodiment of the invention approximating R(M,t) by a probability weighted average of differential rates of dissolution of the ingredient determined under a plurality of n in vitro dissolution conditions each simulating a corresponding member of the plurality of n component dissolution conditions:

$$R ( M , t ) = {\sum }_{i = 1}^{n} {p}_{i} ( z ) \cdot {r}_{i} ( M , {t}_{c} , {t}_{i} ) + ɛ \qquad ( 15. )$$

where each of the linear coefficients, in place of t of equation (14.), is simply a percent probability, pᵢ(z), of the finding of variables of the in vivo dissolution condition that fall within a range of variation represented by a corresponding (i-th) member of the plurality of n component dissolution conditions, in the complex in vivo dissolution process, at location z.

For a solid dosage product consisting of a plurality of particulates that transit through the GI tract as a single fraction, the single fraction dissolving under the complex in vivo dissolution condition of the GI tract in a complex in vivo dissolution process, equation (15.) is written with modifications in definition of certain symbols, namely, replacing the single particulate with the single fraction and the point of space z with a region of space z, in accordance with a preferred embodiment of the invention.

In a case of a solid dosage product comprising a plurality of particulates that transit through the GI tract as several (i.e., N, N being an integer>1) fractions each at a different transit rate in an complex in vivo dissolution process, a modified equation (15.) is written for each of the fractions replacing the single particulate with a fraction of the particulates in the definition of symbols, and point of space z with region of space z, in accordance with a preferred embodiment of the invention. Assigning a subscript j to each symbol that represents a property of a j-th fraction of the particulates, the modified equation (15.) is written in the following form:

$${R}_{j} ( {M}_{j} , t ) = {\sum }_{i = 1}^{n} {p}_{i} ( {z}_{j} ) \cdot {r}_{ij} ( {M}_{j} , {t}_{c} , {t}_{ij} ) + {ɛ}_{j} \qquad ( 16. )$$

Differential rate of dissolution of the ingredient dissolving from the solid dosage product in the GI tract is computed as:

$$R ( M , t ) = {\sum }_{j = 1}^{N} {R}_{j} ( {M}_{j} , t ) \qquad ( 17. )$$

where R(M, t) denotes differential rate of dissolution of the ingredient dissolving from the solid dosage product in the GI tract at a point of time t when cumulative mass dissolved from the solid dosage product is

$$M = {\sum }_{j = 1}^{N} {M}_{j} ,$$

and the remaining symbols have same meanings as in equation (16.).

In a case of a solid dosage product comprising a plurality of particulates that transit through the GI tract as several (N) fractions each at a different transit rate and each initially (i.e., at time of fractionation) consisting of a composition sufficiently similar to another, representing initially a quantitative fraction of the plurality of particulates at a fractional number fⱼ=wⱼ/w₀ (for a j-th member of the several fractions, where wⱼ and w₀ denote initial mass of the ingredient of the j-th fraction and of the whole plurality of particulates, respectively), the following forms of equation (16.) are used each in accordance with a preferred embodiment of the invention, incorporating equations (10.) and (11.), respectively:

$$\begin{matrix}{R}_{j} ( {M}_{j} , t ) = {\sum }_{i = 1}^{n} {p}_{i} ( {z}_{j} ) \cdot {f}_{j} \cdot {r}_{i} ( \frac{{M}_{j}}{{f}_{j}} , {t}_{c} , {t}_{ij} ) + {ɛ}_{j} , & ( 18. ) \\ {R}_{j} ( {F}_{j} , t ) = {\sum }_{i = 1}^{n} {p}_{i} ( {z}_{j} ) \cdot {r}_{i} ( {F}_{j} , {t}_{c} , {t}_{ij} ) + {ɛ}_{j} & ( 19. )\end{matrix}$$

and the following forms of equation (17.):

$$\begin{matrix}R ( M , t ) = {\sum }_{j = 1}^{N} {\sum }_{i = 1}^{n} {p}_{i} ( {z}_{j} ) \cdot {f}_{j} \cdot {r}_{i} ( \frac{{M}_{j}}{{f}_{j}} , {t}_{c} , {t}_{ij} ) + ɛ , & ( 20. ) \\ R ( F , t ) = {\sum }_{j = 1}^{N} {\sum }_{i = 1}^{n} {p}_{i} ( {z}_{j} ) \cdot {r}_{i} ( {F}_{j} , {t}_{c} , {t}_{ij} ) + ɛ & ( 21. )\end{matrix}$$

where

$$ɛ = {\sum }_{j = 1}^{N} {ɛ}_{j} ; {r}_{i} ( \frac{{M}_{j}}{{f}_{j}} , {t}_{c} , {t}_{ij} ) and {r}_{i} ( {F}_{j} , {t}_{c} , {t}_{ij} )$$

where denote differential rate of dissolution of the ingredient of the solid dosage product under an in vitro dissolution condition simulating an i-th component dissolution condition, expressed with reference to absolute mass and percent mass dissolved therefrom, respectively, and a dissolution medium contact time of t_{c} effectively equal to t (and time for the ingredient to reach the cumulative mass dissolved, Mⱼ/fⱼ or F^{j}, in an in vitro dissolution process being tᵢⱼ, if dissolution condition of the in vitro process were to consist of only the i-th dissolution condition); Rⱼ(Mⱼ,t) and Rⱼ(Fⱼ,t) denote differential rate of dissolution of the ingredient of a j-th fraction of the solid dosage product in the GI tract, expressed with reference to absolute mass and percent mass dissolved from the j-th fraction respectively, at a point of time t when cumulative mass of the ingredient dissolved therefrom is Mⱼ and Fⱼ, respectively; and other symbols are as defined either immediately above or in equations (16.) and (17.).

In each of the equations (14.) to (21.) above, each symbol that denotes a differential rate of dissolution, e.g., R(F,t) and rᵢ(Fⱼ,t_{c},tᵢⱼ) in equation (21.), is shown with sub-symbols denoting both cumulative mass dissolved, e.g., F and Fⱼ, and time to reach the cumulative mass dissolved, e.g., t and tᵢⱼ, in a dissolution process, as or among variables of a function for the rate, in order to illustrate relationships between the time and the mass within a function, and between functions, in each of the equations. It is understood that, given a dissolution process, cumulative mass dissolved and time to reach the cumulative mass dissolved in the dissolution process has a fixed relationship (i.e., mutually dependent). Accordingly, when reference is made to a dissolution process, the symbol denoting differential rate of dissolution may be rewritten with either the mass or the time omitted, e.g., R(F,t)=R(t) and R(F,t)=R(F); and, rᵢ(Fⱼ,t_{c},t_{y})=rᵢ(t_{c},tᵢⱼ) and rᵢ(Fⱼ,t_{c},tᵢⱼ)=rᵢ(Fⱼ,t_{c}). In the latter case, with the reference to the dissolution process, t_{c}=tᵢⱼ dependent on Fᵢⱼ (and vice versa), and thus, further, rᵢ(t_{c},tᵢⱼ)=rᵢ(tᵢⱼ), rᵢ(Fⱼ, t_{c})=rᵢ(Fⱼ), and rᵢ(Fⱼ,t_{c})=rᵢ(tᵢⱼ).

When reference is made to a dissolution condition, the sub-symbol for time of dissolution, e.g., tᵢⱼ, of a dissolution process is irrelevant, and a symbol denoting a differential rate of dissolution, e.g., rᵢ(Fⱼ,t_{c},tᵢⱼ), under a given dissolution condition may be rewritten with the time of dissolution process omitted, e.g., rᵢ(Fⱼ,t_{c},tᵢⱼ)=rᵢ(Fⱼ,t_{c}), in equations (14.) to (21.) above.

It is noted that, where an r(M,t_{c}) function, or a portion thereof, is substantially independent of t_{c}, the r(M,t_{c}) function, or the portion thereof, is essentially characterized by a single r(M) function, or a corresponding portion thereof, respectively. In such a case, the term “t_{c} effectively equal to t”, as used herein, means t_{c} set at a value that effectively refers to a value of r substantially equal to the value of r at t_{c} equal to t on a 3-D r(M,t_{c}) surface, given the M. For example, in FIG. 1B, where the portion of an envisioned 3-D r(M, t_{c}) surface passing through curves 19 and 20 shows substantial independence of r on t_{c}, e.g., after 50% cumulative mass is dissolved, t_{c} effectively equal to t means any t_{c} under the 3-D r(M, t_{c}) surface given the M. In the present disclosure, “t_{c} effectively equal to t” is sometimes expressed as “t_{c}=t”.

A characteristic feature of linear modeling in accordance with a preferred embodiment of the invention is that a relationship is established in differential rates of dissolution between an in vivo dissolution process and an in vitro dissolution condition, i.e., the use of, e.g., equation (14.). An in vivo dissolution rate function computed from, e.g., equation (14.), based on such a linear modeling relationship, may then be provided as an input to an absorption model for, e.g., computation of absorption rate and extent based on differential equations governing an in vivo absorption process. Alternatively, a linear modeling equation of the general form of equation (14.) may be incorporated directly into a physiologically-based pharmacokinetic (PBPK) model modeling or simulating absorption, distribution, metabolism, and elimination (ADME) of an active ingredient in an in vivo system, and a relationship established between an in vitro dissolution rate function and an in vivo metric such as blood concentration-time profile. This is in contrast to traditional methods of IVIVC that empirically correlate cumulative mass dissolved with cumulative mass absorbed, between an in vitro dissolution process and an in vivo absorption process, assuming (but without mechanistic and physical support, and indeed, contrary thereto) existence of a simple algebraic relationship therebetween.

In each of the equations (14.), (15.), (16.), (18.), and (19.), in accordance with the teaching of the particular embodiments of the invention, linear combination of dissolution rates is done at identical points of cumulative mass (M, Mⱼ, Mⱼ/fⱼ, or Fⱼ) of the ingredient dissolved, and t_{c}=t, while an in vitro process-dependent time (tᵢ or tᵢⱼ) is treated to be generally different from an in vivo process-dependent time (t).

In each of the equations (20.) and (21.) in the other particular embodiments of the invention, linear combination of dissolution rates is computed while both cumulative mass dissolved and time of dissolution are treated to be generally different between an in vitro process and the in vivo process. This is in contrast to traditional methods, which popularly teach or assume identical tᵢ (or tᵢⱼ) and t at a given M in IVIVC, even when dissolution condition (including time-function and heterogeneity thereof) of an in vitro dissolution process clearly differs from that of an in vivo (compare, e.g., a USP type II continuously stirred in vitro hydrodynamic dissolution condition and a lumenal peristaltic in vivo GI hydrodynamic dissolution condition).

The error term ε in equation (14.) is defined as difference between R(M,t) and

$${\sum }_{i = 1}^{n} {η}_{i} \cdot {r}_{i} ( M , {t}_{c} , {t}_{i} ) ,$$

where t_{c}=t and ηᵢ is coefficient of the linear model used for computation of R(M,t), ε accounting for dissolution of the ingredient under component dissolution conditions of the complex dissolution process that are not collectively simulated by the plurality of in vitro dissolution conditions. In preferred embodiments of the invention where the plurality of in vitro dissolution conditions in combination adequately simulates (i.e., is treated as an adequate simulation of) variation in values of variables of the complex dissolution condition, s is considered small and omitted from the equation (i.e., treated as zero). In an equivalent manner, where an error term in each of the equations (15.), (16.), and (18.) to (21.) is considered negligible, the error term is omitted therefrom.

Other features of the inventive steps of the evaluating of differential rate of dissolution of an ingredient of a solid dosage product dissolving in a complex dissolution process, as a linear combination of rate functions determined under in vitro dissolution conditions simulating component dissolution conditions of the complex dissolution process, include:

(a.) various schemes are possible by which component dissolution conditions of a complex dissolution process may be identified, and a form of equation (14.) written for use in accordance with a preferred embodiment of the invention;

(b.) a more complex dissolution condition may be treated as a combination or a mixture of a plurality of less complex component dissolution conditions (until a component dissolution condition is a simple dissolution condition);

(c.) given a plurality of rate functions rᵢ(M,t_{c}) and a plurality of corresponding linear modeling coefficients ηᵢ, there is defined a dissolution rate curve R(M,t) in accordance with a form of equation (14.) for a dissolution process (simulative or real); and

(d.) treating t_{c} as part of a component dissolution condition of a dissolution process (simulative or real), i.e., t_{c}=t (the dissolution process time, which is a function of M given the dissolution process), the right side of equation (14.) is essentially a weighted average of r(M) functions determined under different component dissolution conditions, i.e., rᵢ(M) the r(M) form of rᵢ(M,t_{c}) curve on an rᵢ(M,t_{c}) surface when t_{c}=t, for i-th component dissolution condition.

Disclosures above teach a principal of separation of variables in accordance with a preferred embodiment of the invention. The principal of separation of variables may be more readily understood if a linear relationship conforming to the mathematical expression of equation (14.) is viewed as a matrix equation. For example, re-write linear modeling equation (14.) as follows:

R(M,t)=η×r+ε (22.)

where η denotes a row matrix, the elements of which consist of ηᵢ(i=1, 2, . . . , n) defined in equation (14.), i.e.,

η={η₁, η₂, . . . ηᵢ, . . . , ηₙ},

r a column matrix, the elements of which consist of rᵢ(M,t_{c},tᵢ) (i=1, 2, . . . , n) defined also in equation (14.), i.e.,

$$r = \{ \begin{matrix}{r}_{1} ( M , {t}_{c} , {t}_{1} ) \\ {r}_{2} ( M , {t}_{c} , {t}_{2} ) \\ ⋮ \\ {r}_{i} ( M , {t}_{c} , {t}_{i} ) \\ ⋮ \\ {r}_{n} ( N , {t}_{c} , {t}_{n} )\end{matrix} \} ,$$

and the remaining symbols are either as defined in equation (14.) or have their ordinary mathematical meanings. It is seen that rate of dissolution, R(Mt), of an ingredient of a solid dosage product dissolving in a complex dissolution process, is essentially a product of multiplication of two matrices, i.e., η and r. It will be understood from the following deductive reasoning that the two matrices represent two substantially independent factors of a complex dissolution process.

Each element, rᵢ(M,t_{c},tᵢ), of the matrix r represents a rate function for dissolution of the ingredient under a given dissolution condition, at different degrees of dissolution of the ingredient and different dissolution medium contact times with the solid dosage product. As such, the matrix r represents a property of dissolution of the ingredient, independent of a dissolution process. See various descriptions of rᵢ(M,t_{c},tᵢ) functions hereinabove.

Each element, ηᵢ, of the matrix η is a linear modeling coefficient, which, in general, has a form of a probability, e.g., pᵢ(z), of finding a particulate, a plurality of particulates, or a fraction of particulates (herein sometimes, generically, “a dissolving solid”), dissolving under a given dissolution condition at a given location, i.e., z, of a dissolution environment, or is a function of the probability. See, e.g., descriptions of equations (15.) to (21.) hereinabove. See also further disclosures hereinafter. Given a transit function, i.e., z(t), for a dissolving solid in a dissolution environment, a probability, e.g., pᵢ(z), essentially defines, statistically, local dissolution condition imposed on the dissolving solid, at location z of the dissolution environment and time t in the dissolution process. Accordingly, the matrix η represents a property of the dissolution environment, more specifically local dissolution environment of the dissolution process, independent of a property of dissolution of a dissolving ingredient, given a vertical velocity of fluidization of and a transit function for the dissolving solid in the dissolution environment (if spatial transit therein is a significant part of the dissolution process, e.g., in a lumenal dissolution environment along the GI tract of a live human).

An advantage of applying the principal of separation of variables in accordance with a preferred embodiment of the invention is that a complex dissolution process in a complex dissolution environment in vivo may now be studied under less complex, more easily controlled conditions, or as less complex, more easily solvable problems, in more accessible (e.g., in vitro) environments. Each of the conditions may be controlled independently from another, and each of the problems (e.g., linear modeling coefficients η and r-M functions) independently attacked.

The term “discrete settlement hydrodynamic dissolution condition”, as used herein, denotes a hydrodynamic dissolution condition imposed on a dissolving particulate as the particulate is let to settle under a net gravity or floatation force acting thereon, from one resting position to another resting position, through a static column of dissolution medium.

The term “resting position”, as used herein, denotes a position on a physical wall or surface, the physical wall or surface defining a boundary of a dissolution environment, against which wall or surface a particulate rests as gravity, buoyancy, and any counter forces acting thereon are balanced out to cause the particulate to remain in a still position.

The term “discrete fluidization and settlement hydrodynamic dissolution condition”, as used herein, denotes a hydrodynamic dissolution condition imposed on a dissolving particulate as the particulate is fluidized from a resting position, under a vertical component of a drag force created by a local dissolution medium flow, the vertical component of the drag force overcoming all other forces (i.e., net gravity or buoyancy force) acting on the particulate, and the particulate is then allowed to settle, under a reduced or a diminished vertical component of the drag force and therefore a net gravity or buoyancy force, to a resting position.

The term “pressure-sensitive packed bed hydrodynamic dissolution condition”, as used herein, denotes a hydrodynamic dissolution condition imposed on a dissolving particulate embedded in a bed of particulates through which a flow of dissolution medium passes under a given pressure gradient.

The term “flow-sensitive fixed position hydrodynamic dissolution condition”, as used herein, denotes a hydrodynamic dissolution condition imposed on a dissolving particulate affixed to a position, while a flow of dissolution medium passes by at a given local velocity without causing the particulate to move along with the flow of dissolution medium.

The term “settling”, as used herein, has a broad meaning and denotes moving (of a particulate) under a net gravity force, or under a net buoyancy force, in a column of dissolution medium. The settling under a net gravity force is sometimes called herein “falling” and the settling under a net buoyancy force is sometimes called herein “rising”.

The term “fluidizing”, as used herein, denotes causing (a particulate) to move, from a resting position, in a direction of local dissolution medium flow, under a net drag force created thereby.

The term “local velocity of dissolution medium flow”, as used herein, denotes velocity of movement of a dissolution medium immediately beyond a boundary (or transition) layer between surface of a particulate and bulk of the dissolution medium, the boundary layer being a thin film of dissolution medium surrounding the particulate, through which velocity of movement of dissolution medium (i.e., the local velocity) transits to velocity of movement, if any, of the particulate.

The term “relative local velocity of dissolution medium flow”, as used herein, denotes local velocity of dissolution medium flow with regard to a particulate, subtracted by velocity of movement of the particulate (i.e., local velocity of dissolution medium flow relative to movement of the particulate).

The term “vertical velocity of fluidization”, as used herein, denotes a minimum vertical component of local velocity of dissolution medium flow, that is required to cause a freely standing particulate to have a vertical component of fluidization.

The term “linear vertical distance of local dissolution medium flow (per unit time)”, as used herein, denotes a distance of movement (per unit time) of an imaginary fluid particle of a dissolution medium, along a vertical path at a velocity equal to the vertical component of a local velocity of the dissolution medium (with regard to a dissolving particulate).

In a preferred embodiment of the invention in the evaluating of rate of dissolution of a solid dosage product, a complex in vivo dissolution process in the GI tract of a live human is treated as one comprising discrete fluidization and settlement hydrodynamic dissolution conditions as component dissolution conditions. Each of the discrete fluidization and settlement hydrodynamic dissolution conditions is simulated under an in vitro discrete fluidization and settlement hydrodynamic dissolution condition. Rates of dissolution measured under the in vitro discrete fluidization and settlement hydrodynamic dissolution condition provide an r(M,t_{c}) function having values over a range of t_{c} that covers an entire range of duration of time t of an in vivo dissolution process. The following form of equation (14.) is used for linear modeling of in vivo rates of dissolution from in vitro rates:

R(M,t)=η_{d}(z)·r_{d}(M,t_{c})+ε_{d} (23.)

where R(M,t) denotes rate of dissolution of an ingredient of the solid dosage product dissolving in the in vivo dissolution process in the GI tract, at time t and cumulative mass of the ingredient dissolved M; η_{d}(z) a GI location (z) specific linear modeling coefficient for the modeling of R(M,t) with r_{d}(M,t_{c}); r_{d}(M,t_{c}) the r(M,t_{c}) rate function for the ingredient of the solid dosage product, determined under the in vitro discrete fluidization and settlement hydrodynamic dissolution condition, and having value at M and t_{c}=t (subscript d indicates discrete fluidization and settlement hydrodynamic dissolution condition); ε_{d} an error term accounting for in vivo dissolution conditions not completely or accurately simulated by the in vitro discrete fluidization and settlement hydrodynamic dissolution condition; and other symbols have their ordinary mathematical meanings.

The preferred embodiment takes advantage of a theory developed by the applicant, for the describing of dissolution of a solid dosage product in the GI tract of a live human. In accordance with the theory, which is summarily presented below as one treatment of description of GI dissolution and not intended to be an only treatment thereof in the embodying of the invention (see another treatment hereinafter):

(a.) Local flow rate of dissolution medium (i.e., gastrointestinal fluid), with regard to a given particulate of a solid dosage product dissolving in the GI tract of a live human, is cyclic (i.e., rises and falls in cycles as a function of time) because of a peristaltic nature of GI motility, a cyclic local flow rate resulting in a particulate being alternately in a fluidized state and a settled state, as the particulate ventures through the GI tract and dissolves therein;

(b.) Each interval of time between a point at which a particulate is fluidized and a next point at which the particulate is again fluidized forms a cycle of a discrete fluidization and settlement hydrodynamic dissolution condition, duration of time of a dissolution process in the GI tract consisting essentially of a time series of such cycles;

(c.) A cycle of discrete fluidization and settlement hydrodynamic dissolution condition consists of a fluidizing period, a settling period, and a resting period, dissolution of a particulate during the resting period (i.e., in a settled state) being negligible, and significant only in the fluidizing and the settling periods (i.e., in a fluidized state);

(d.) While global hydrodynamic dissolution condition in the GI tract may be highly complex, local hydrodynamic dissolution condition with regard to a particulate dissolving in a fluidized state is essentially constant, characterized by a relative local velocity of dissolution medium flow substantially equal to vertical velocity of fluidization Vᵥ(>0) of the particulate, an essentially constant local hydrodynamic dissolution condition causing the particulate to dissolve at a rate essentially independent of a changing global hydrodynamic dissolution condition at any time the particulate is in a fluidized state;

(e.) Local dissolution medium flow during a cycle of discrete fluidization and settlement hydrodynamic dissolution condition with regard to a particulate having a given vertical velocity of fluidization Vv, the particulate at time t having transited to region z in the GI tract, following a transit function z(t), is characterized by a linear vertical distance D(z) (D expressed as a function of z) or D(t) (D expressed as a function oft, related to D(z) by the transit function for the particulate) of the local dissolution medium flow, per unit time, given by the following deductively derived equation:

$$D ( z ) or D ( t ) = \frac{{\int }_{{t}_{1}}^{{t}_{f}} {U}_{v} \cdot d t}{{t}_{2} - {t}_{1}} \qquad ( 24. )$$

where Uᵥ denotes vertical velocity of local dissolution medium flow with regard to a particulate following the transit function z(t), t₁ time at which a cycle of discrete fluidization and settlement hydrodynamic dissolution condition begins (i.e., the point at which the particulate is fluidized), t₂ time at which the cycle ends (i.e., the point at which the particulate is again fluidized, which is also the point at which a next cycle begins), t_{f} time at which fluidized state ends and settled state begins within the cycle, t_{f} being in the range of t₁ to t₂, and other symbols either are as defined above or have their ordinary mathematical meanings;

(f.) Probability, p_{f}(z) or p_{f}(t), of finding a particulate dissolving in a fluidized state at time t and region z, the particulate having the given vertical velocity of fluidization and following the transit function z(t), is theoretically related to D(z) or D(t), respectively, by the following deductively derived equations:

$${p}_{f} ( z ) = \frac{D ( z )}{{V}_{v}} and {p}_{f} ( t ) = \frac{D ( t )}{{V}_{v}} \qquad ( 25. )$$

(g.) Particulates having a same vertical velocity of fluidization, and following a same transit function in the GI tract, are subjected to a linear vertical distance of local dissolution medium flow per unit time statistically the same among the particulates;

(h.) Given an in vitro dissolution process comprising an in vitro discrete fluidization and settlement hydrodynamic dissolution condition, under which r_{d}(M,t_{c}) of equation (23.) is determined, dᵥ replaces D(z) and D(t) in an equation similar to equation (24.), for the in vitro discrete fluidization and settlement hydrodynamic dissolution condition;

(i.) In a case of a solid dosage product consisting of a single dissolving particulate, or a plurality of dissolving particulates transiting as one fraction and subjected to statistically same D(z), η_{d}(z) in equation (23.) is theoretically the ratio D(z)/dᵥ, corrected by any factor that may be necessary due to difference in physicochemical properties of dissolution medium between the in vitro and the in vivo dissolution conditions, that may linearly affect rates of dissolution (by, e.g., a change in solubility of the dissolving ingredient);

(j.) Where particulates of a solid dosage product transit in the GI tract as one fraction but different vertical velocities of fluidization subject the particulates to statistically different D(z), dᵥ under the in vitro dissolution condition may be so controlled that a substantially same ratio of D(z)/dᵥ is maintained for particulates having the different vertical velocities of fluidization, and η_{d}(z) is theoretically equal to D(z)/dᵥ, corrected by any factor that may be necessary due to difference in physicochemical properties of dissolution medium between the in vitro and the in vivo dissolution conditions; and

(k.) Given dᵥ, η_{d}(z)=D(z)/dᵥ in equation (23.) is a property of the GI tract and the transit function z(t), because D(z) is. Alternatively, r_{d}(M,t_{c}) in equation (23.) being replaced with r_{d}(M,t_{c}) divided by dᵥ, i.e., mass of the ingredient dissolved per unit linear vertical distance of local dissolution medium flow, η_{d}(z) is directly D(z).

Replacing of D(z), dᵥ, η_{d}(z), and r_{d}(M,t_{c}) with H(z), hᵥ, ηₛ(z), and rₛ(M,t_{c}), respectively, provides equations similar to (23.) and (25.), that apply to a discrete settlement hydrodynamic dissolution condition (the accelerating phase thereof, i.e., prior to reaching terminal velocity of settlement; dissolution thereafter is equivalent to dissolution under a discrete fluidization and settlement hydrodynamic dissolution condition), where H(z) and hᵥ are linear vertical distance of settlement per unit time in vivo and in vitro, respectively, rₛ(M,t_{c}) the r(M,t_{c}) function determined in vitro under a discrete settlement hydrodynamic dissolution condition (of hᵥ), and ηₛ(z)=H(z)/hᵥ.

In another preferred embodiment of the invention, a complex in vivo dissolution process in the complex, peristaltic, in vivo lumenal environment of the GI tract is treated as a process further comprising pressure-sensitive packed bed hydrodynamic conditions as component dissolution conditions. The pressure-sensitive packed bed hydrodynamic conditions are simulated in vitro under an in vitro pressure-sensitive packed bed hydrodynamic dissolution condition at one or more head pressures. At several head pressures, the following form of equation (14.) is used:

$$R ( M , t ) = {η}_{d} ( z ) \cdot {r}_{d} ( M , {t}_{c} ) + {\sum }_{p = 1}^{n} {η}_{p} ( z ) \cdot {r}_{d} ( M , {t}_{c} ) + {ɛ}_{dp} \qquad ( 26. )$$

where ηₚ(z) denotes a GI location (z) specific linear modeling coefficient for modeling R(M,t) with rₚ(M,t_{c}); rₚ(M,t_{c}) the r(M,t_{c}) function for the ingredient dissolving from the plurality of particulates, determined under the in vitro pressure-sensitive packed bed hydrodynamic dissolution condition at a p-th head pressure, and having a value at M and t_{c}=t; ε_{dp} an error term accounting for in vivo dissolution conditions not completely or accurately simulated by the combination of in vitro discrete fluidization and settlement hydrodynamic dissolution condition, and in vitro pressure-sensitive packed bed hydrodynamic dissolution condition; and other symbols are as defined in equation (23.).

Where the r(M,t_{c}) function under the pressure-sensitive packed bed hydrodynamic dissolution condition at one head pressure is linearly related to the function at another, equation (26.) has the following simplified form:

R(M,t)=η_{d}(z)·r_{d}(M,t_{c})+ηₚ(z)·rₚ(M,t_{c})+ε_{dp} (27.)

where rₚ(M,t_{c}) is now the r(M,t_{c}) function determined at a given head pressure, and ηₚ(z) a GI location(z)-specific linear modeling coefficient for the modeling of R(M,t) with rₚ(M,t_{c}).

The preferred embodiment comprising the use of equation (26.) or (27.) takes advantage of an expanded theory (non-limiting) developed by the applicant, the expanded theory taking into consideration of dissolution of a particulate under a pressure-sensitive packed bed hydrodynamic dissolution condition.

In accordance with the expanded theory, a pressure-sensitive packed bed hydrodynamic dissolution (in vitro or in vivo) is characterized by a plurality of features, including: (a.) shape of a packed bed; and (b.) pressure gradient of dissolution medium in the packed bed. The following deductively derived equation theoretically describes factors contributing to rate of dissolution of a plurality of particulates dissolving under a pressure-sensitive packed bed hydrodynamic dissolution condition:

$${r}_{p} ( M , {t}_{c} ) = {C}_{0} \cdot ω \cdot \int {\int }_{A} Δ P \cdot ( 1 - {e}^{- \frac{D \cdot S}{Δ P \cdot ω \cdot h} \cdot \frac{L}{V}} ) \cdot d A \qquad ( 28. )$$

where C₀ denotes solubility of the dissolving ingredient; ω specific hydraulic conductivity of the plurality of particulates; ΔP head pressure along a given flow line through the pile; D diffusion coefficient of the dissolving ingredient dissolved in the dissolution medium; S surface area of the dissolving ingredient exposed to dissolution medium; A surface area of the pile where dissolution medium enters the pile; L length of the given flow line; V volume of the pile; h thickness of a boundary layer of a dissolving particulate; and other symbols either are as defined above or have their ordinary mathematical meanings. It is understood that ω, S, h, A, L, and V each is a function of M and t_{c}, and ΔP a function of GI location z as well as the given flow line.

For a plurality of particulates packed into a bed of a cylindrical shape (e.g., in an in vitro dissolution test), the following special form of equation (28.) is deductively derived:

$${r}_{p} ( M , {t}_{c} ) = {C}_{0} \cdot ω \cdot Δ P \cdot ( 1 - {e}^{- \frac{D \cdot S}{Δ p \cdot ω \cdot h} \cdot \frac{1}{A}} ) \cdot A \qquad ( 29. )$$

where ΔP and A now have well-defined values.

Equation (28.) teaches that, when a solid dosage product comprises a plurality of particulates having a sufficiently low specific hydraulic conductivity ω (e.g., when the product contains certain polymeric excipients of high impedance to hydraulic flow of an aqueous dissolution medium), pressure gradient across a packed bed of the particulates being low (typically true in the GI tract of a mammal, else, the particulates would fluidize), and S being sufficiently high (e.g., at an early stage of a dissolution process) the exponential term in equation (28.) approaches zero, and the integral term approximately becomes

$$\int {\int }_{A} Δ P \cdot d A ,$$

which is essentially a term dependent on dissolution environment, given a transit function of the particulates therein and given a bulk volume of the particulates and a shape assumed thereby as governed by the transit function and cohesive properties of the particulates. In such a case, the rate function rₚ(M,t_{c}) is essentially a (linear) function of the specific hydraulic conductivity given the bulk volume and the cohesive properties, and typically has low values.

In other preferred embodiments of the invention, a complex in vivo dissolution process in the GI tract of a live human may be treated as one comprising other or further component dissolution conditions including discrete settlement hydrodynamic dissolution condition and flow-sensitive fixed position hydrodynamic dissolution condition.

A discrete settlement hydrodynamic dissolution condition in the GI tract may occur when, e.g., a part of the lumenal wall of the GI tract against which a particulate rests moves in a direction that causes imbalance of forces acting on the particulate, and the particulate falls under a net gravity force through a static column of the GI fluid. Dissolution of a particulate under a discrete settlement hydrodynamic dissolution condition differs slightly from dissolution of the particulate in a fluidized state of a discrete fluidization and settlement hydrodynamic dissolution condition described herein before, in that relative local velocity of dissolution medium flow at the start of the settling is zero, accelerating therefrom towards a steady state velocity determined by the vertical velocity of fluidization of the particulate. The vertical velocity of fluidization may be closely approached only if the static column of dissolution medium through which the settling occurs is of a sufficient height, given a value of the vertical velocity of fluidization of the particulate.

A flow-sensitive fixed position hydrodynamic dissolution condition may occur when, e.g., a dissolving solid dosage product is affixed to a position and subjected to a local dissolution medium flow at a given flow rate. It may also occur when a wall on which a particulate rests pushes against a body of dissolution medium, and moves at a given speed.

In other in vivo dissolution environments, a dissolving solid dosage product may be affixed to a position, or dissolves in a fluid-scarce environment, and is subjected to no substantial fluidization. These other in vivo dissolution environments include, e.g., (a.) lumenal and capillary dissolution environment of respiratory tract of a live human, (b.) lumenal dissolution environment of rectal tract thereof, (c.) lumenal dissolution environment of vaginal tract thereof, (d.) dissolution environment of a patch or cream applied to a skin surface thereon, (e.) dissolution environment in a tissue thereof for a solid dosage product implanted or injected therein, and (f.) lumenal dissolution environment of a blood vessel thereof for a drug-eluting stent affixed to a position therein. In such a case, an in vivo dissolution process is treated, in preferred embodiments of the invention, as one comprising only one or a combination of hydrodynamic dissolution conditions selected from the group consisting of pressure-sensitive packed bed hydrodynamic dissolution condition and flow-sensitive fixed position hydrodynamic dissolution condition.

In yet other preferred embodiments of the invention, the resting period of a cycle of discrete fluidization and settlement hydrodynamic dissolution condition, in vivo, is treated as one comprising either a pressure-sensitive packed bed hydrodynamic dissolution condition or a flow-sensitive fixed position, and simulated likewise in vitro. Thus, a resting period of an in vitro dissolution test comprises a period of dissolution medium flow at a given head pressure or flow rate, respectively, and a vertical velocity less than vertical velocity of fluidization of a particulate or plurality of particulates. Duration of the period of dissolution medium flow at the given head pressure or flow rate is experimentally set to reflect a relative duration in vivo. An r_{d}(M,t_{c}) function, in, e.g., equation (23.), determined in vitro, includes contribution from dissolution under the pressure-sensitive packed bed hydrodynamic dissolution condition or the flow-sensitive fixed position.

While in many cases mathematical formulas may be deductively derived for computing a coefficient of a linear modeling equation of the general form of equation (14.), in practice, a linear modeling coefficient, e.g., η_{d}(z) in equation (23.), is or has to be obtained from the fitting of the linear model to in vitro dissolution rate data and corresponding in vivo dissolution rate data. In a case of human medicine, the in vivo dissolution rate data cannot be directly determined, but may be computed from, e.g., clinically measurable plasma concentration-time profile data, via a PBPK model or method. Alternatively, the in vitro dissolution rate data may be fed into a PBPK model and a linear modeling coefficient estimated by a best matching of Monte Carlo simulation results with the clinically measurable results. An advantage of linear modeling in accordance with a preferred embodiment of the invention, e.g., the embodiment comprising the use of equation (23.), over a method of the prior art, is that, a linear model, established in a form of η, e.g., η_{d}(z) of equation (23.), may be valid across different products, as long as the different products are grossly similar in physical properties of particulates (e.g., gross size and vertical velocity of fluidization), so that any spatial transit in the in vivo dissolution environment (e.g., along the GI tract of a live human) is substantially same among the different products. An established linear model (i.e., η), in combination with a PBPK model, allows direct computation of pharmacokinetic outcome of a solid dosage product, from in vitro dissolution testing results obtained on the solid dosage product. For a description of a PBPK model or method, see, e.g., U.S. Pat. No. 6,647,358 issued on Nov. 11, 2003 to Grass et al. See also, e.g., an in vivo absorption model and an in vivo PK model described by Yu et al (2001), AAPS PharmSciTech, 3(3): article 24. The cited references are incorporated herein in entirety.

In the manufacturing of a solid dosage pharmaceutical in the controlling of bioequivalence of a production batch thereof (or formulation or process) to a target batch (or formulation or process), complete knowledge of η is not necessary and bioequivalence can be ensured if in vitro dissolution rates each as a said advantageous function determined and evaluated in accordance with a preferred embodiment of the invention under each of the in vitro dissolution conditions simulating the component dissolution conditions of the in vivo dissolution process directly and completely match those of the target batch (or product) (assuming that the batch or product does not change η nor ADME of a dissolved active ingredient). This is because η represents the environmental factor, and the in vitro dissolution rates (each as a said advantageous function) the product factor, of rate of dissolution of a solid dosage pharmaceutical in the in vivo dissolution process. See the principal of separation of variables described herein above. Knowledge of η, however, allows the evaluation of in vitro dissolution rates that do not directly and completely match those of the target, against a specification on a simulated in vivo dissolution rate function computed by way of a linear modeling equation of the general form of equation (14.). Knowledge of η also allows the setting of a quality control target range of a specification on the in vitro dissolution rates.

The present invention, accordingly, teaches innovative steps of a method of manufacturing a solid dosage product, to achieve a desired or targeted rate of dissolution of an ingredient thereof in an in vivo dissolution process. Referring to FIG. 2, the innovative steps of the method, in a preferred embodiment thereof, comprise a step (28) of the determining and the evaluating of rate of dissolution of the ingredient, as a function of cumulative mass of the ingredient dissolved from the solid dosage product, under each of a plurality of in vitro dissolution conditions each simulating a component dissolution condition of the in vivo dissolution process. The evaluating comprises a direct comparing of value of the rate of dissolution, with value of a predetermined target on the rate of dissolution, either continuously over a range of continuous value of the cumulative mass of the ingredient dissolved, or discretely at each of a plurality of discrete values or over each of a plurality of discrete ranges of values thereof. The predetermined target may comprise a predetermined quality control specification of allowable range of values, the specification being established from knowledge of a reference product or reference production batches, any knowledge of η with regard to the product or similar products, and any knowledge of PBPK with regard to the dissolving active ingredient. Based on whether the rate of dissolution, determined and evaluated as a said advantageous function, meets the predetermined target, a manufacturing decision may be made (29, FIG. 2), such as: (1.) acceptance or rejection of a production batch or lot of the solid dosage product; (2.) acceptance or rejection of a formulation or production process; and (3.) in a case where the rate of dissolution, as a said advantageous function, fails to meet the predetermined target, change, modification, or adjustment of variables of formulation and/or production process to effect a change in the rate of dissolution so that the rate of dissolution meets the predetermined target.

In an equivalent manner, other properties of dissolution, such as vertical velocity of fluidization and specific hydraulic conductivity, are also, preferably, determined, evaluated, and/or controlled as a function of, at least, the cumulative mass dissolved.

η being established, the evaluating (28, FIG. 2) comprises the modeling and the simulating of rate of dissolution of the ingredient in the in vivo dissolution process, as a linear combination of rates of dissolution of the ingredient determined as said advantageous functions under said plurality of dissolution conditions. The rate of dissolution from the simulating, instead of directly the rate of dissolution determined in vitro, is compared to a predetermined target, to allow a manufacturing decision (29, FIG. 2) to be made accordingly. Alternatively, a PBPK model being established, the rate of dissolution from the simulating is fed to the PBPK model and the comparing is done between a simulated pharmacokinetic output and a predetermined target on a pharmacokinetic property (e.g., maximum systemic blood concentration, Cₘₐₓ, and area under the blood concentration-time curve, AUC) of the solid dosage product. Further, pharmacodynamic modeling may be performed to provide an endpoint evaluation of an in vitro rate of dissolution.

η being known, a direct experimental simulation of an in vivo dissolution process is performed in a single in vitro dissolution process in accordance with a preferred embodiment of the invention. The single in vitro dissolution process has a cyclic dissolution condition each cycle thereof consisting of a time-series of dissolution conditions each thereof simulating a component dissolution condition of the in vivo dissolution process for a relative duration to length of cycle reflecting probability of occurrence of the component dissolution condition at a point of time in the in vivo dissolution process equal to a point of time of the cycle in the in vitro dissolution process. The relative duration is chosen according to η.

Further, the evaluating comprises the computation and the comparison of AUrMC, mean differential rate of dissolution over mass, and mean dissolution time.

It is a general feature of the invention that, in the evaluating and the testing of rate of dissolution of an ingredient of a solid dosage product, focus is placed on local dissolution condition for a dissolving solid. Local dissolution condition, such as local velocity of dissolution medium flow, especially relative local velocity of dissolution medium flow, is treated as most relevant and most critical of a dissolution environment, given a dissolution process therein. Alternatively stated, the method of the invention focus on local dissolution environment of a dissolution process, instead of global dissolution condition of a dissolution environment. By definition herein, all physicochemical and hydrodynamic dissolution conditions of a dissolution process refer to local physicochemical and hydrodynamic dissolution conditions of a local dissolution environment of a dissolving solid of the dissolution process.

A property equivalent to differential rate of dissolution, e.g. a mathematical e.g. linear transformation thereof, may preferably be determined as a said advantageous function. Specific examples of such a property include: (A.) mass of an ingredient dissolved per unit linear vertical distance of local dissolution medium flow of a discrete fluidization and settlement hydrodynamic dissolution condition; (B.) mass of an ingredient dissolved per unit linear vertical distance of settlement of a discrete settlement hydrodynamic dissolution condition; (C.) mass of an ingredient dissolved per unit linear distance of local dissolution medium flow of a fixed position hydrodynamic dissolution condition; (D.) mass of an ingredient dissolved per unit linear distance of dissolution medium flow through a packed bed of a pressure-sensitive packed bed hydrodynamic dissolution condition; and (E.) differential rate of dissolution scaled by a factor chosen according to either an in vivo dissolution condition or its difference from a simulative in vitro dissolution condition. Such difference may include, for example, difference in: (A.) solubility of the ingredient in dissolution medium; (B.) linear vertical distance of local dissolution medium flow per cycle of a discrete fluidization and settlement hydrodynamic dissolution condition; (C.) linear vertical distance of settlement per cycle of a discrete settlement hydrodynamic dissolution condition; (D.) viscosity of dissolution medium; (E.) head pressure of a pressure sensitive packed bed hydrodynamic dissolution condition; and (F.) dissolution medium flow rate of a flow sensitive fixed position hydrodynamic dissolution condition. Mathematical e.g. linear transformation (e.g., division by dᵥ) of AUrMC and mean differential rate over mass will similarly occur to those skilled in the art taught by the present disclosure. Linear combination of AUrMC determined under component dissolution conditions to yield an AUrMC for a simulated in vivo dissolution process, will occur from integration of equation (14.) over mass. Computation of area under the curve of a property versus cumulative mass dissolved, and mean value of the property over mass, for a p(M) function where the p denotes such a property as hydraulic conductivity, porosity, or vertical velocity of fluidization, will be apparent from the teaching of computation of AUrMC and associated measures thereof. With regard to dissolution under an i-th dissolution condition repetitively occurring at i-th named time points or in i-th named time periods throughout an in vitro dissolution process, among time points or periods of another or other dissolution conditions different from dissolution condition of the i-th named time points or periods, the following formulas will occur to those skilled in the art taught by the present disclosure:

$$\begin{matrix}\begin{matrix}{r}_{i} ( {t}_{i} ) = \frac{d M}{d {t}_{i}} \\ = r ( t ) \\ = \frac{d M}{d t} ,\end{matrix} & \\ \begin{matrix}{\int }_{A}^{B} {r}_{i} ( M ) \cdot d M = {\int }_{{t}_{iA}}^{{t}_{iB}} {r}_{i} ( {t}_{i} ) \cdot {r}_{i} ( {t}_{i} ) \cdot d {t}_{i} \\ = {\int }_{{t}_{A}}^{{t}_{B}} {r}_{i} ( t ) \cdot r ( t ) \cdot d t ,\end{matrix} & \\ and & \\ \begin{matrix}{\int }_{A}^{B} p ( M ) \cdot d M = {\int }_{{t}_{iA}}^{{t}_{iB}} p ( {t}_{i} ) \cdot {r}_{i} ( {t}_{i} ) \cdot d {t}_{i} \\ = {\int }_{{t}_{A}}^{{t}_{B}} p ( t ) \cdot r ( t ) \cdot d t\end{matrix} & \end{matrix}$$

where rᵢ(M) denotes an r(M) function determined under the i-th dissolution condition; rᵢ(tᵢ) time domain form of the rᵢ(M); tᵢ time of said time domain; t time of the dissolution process; rᵢ(t) the rᵢ(tᵢ) mapped from tᵢ to t; p(t) time domain form of the p(M); p(tᵢ) the p(t) mapped from t to tᵢ; A and B a pair of values defining a given range of the cumulative mass M; t_{A} and t_{B} value of the t when M is at the A and the B, respectively, and t_{iA} and t_{iB} value of the tᵢ; and other symbols are either as defined above or have ordinary mathematical meanings.

It will also be apparent to those skilled in the art taught by the present disclosure, that, while it is preferred to directly determine and evaluate a property of dissolution in an advantageous form, or manner, as described herein, e.g., as a said advantageous function, and make a manufacturing decision based on result of the determining and the evaluating in the controlling of the property to within range of a specification, it is possible to equivalently control the property to within the range by the determining and the evaluating of another property equivalent to the property and control the another property to within range of a specification on the another property corresponding to range of the specification on the property. Further, it is possible to experimentally establish and/or validate a physical relationship between a production variable (e.g., film thickness of a tablet coating or compression pressure) and the property of dissolution, and monitor the production variable controlling same to within range of a specification that has been found, by way of the experimental establishing and/or validating, to correspond to the range of the specification on the property. Additionally, a physical relationship may be experimentally established and/or validated between attribute and/or composition of a raw material (e.g., polymorphic form or particle size of an active ingredient) and the property of dissolution, so that the monitoring and controlling of the attribute equivalently controls the property of dissolution to within range of the specification. Yet further, a property of an intermediate product (e.g., a property of dissolution of granules prior to tableting or encapsulating) may be monitored and controlled to within range of a specification corresponding to range of the specification on the property of dissolution, via a known or established physical relationship therebetween. The term “controlling”, as used in the present patent document, denotes ensuring or causing of value of (a metric, e.g., a property of a solid dosage product), by way of, e.g., monitoring of and acting based on the value or that of an underlying factor contributing thereto having a known or validated physical relationship therewith, to meet a specification either directly on the value or, after a mathematical manipulation of the value, on result of the mathematical manipulation.

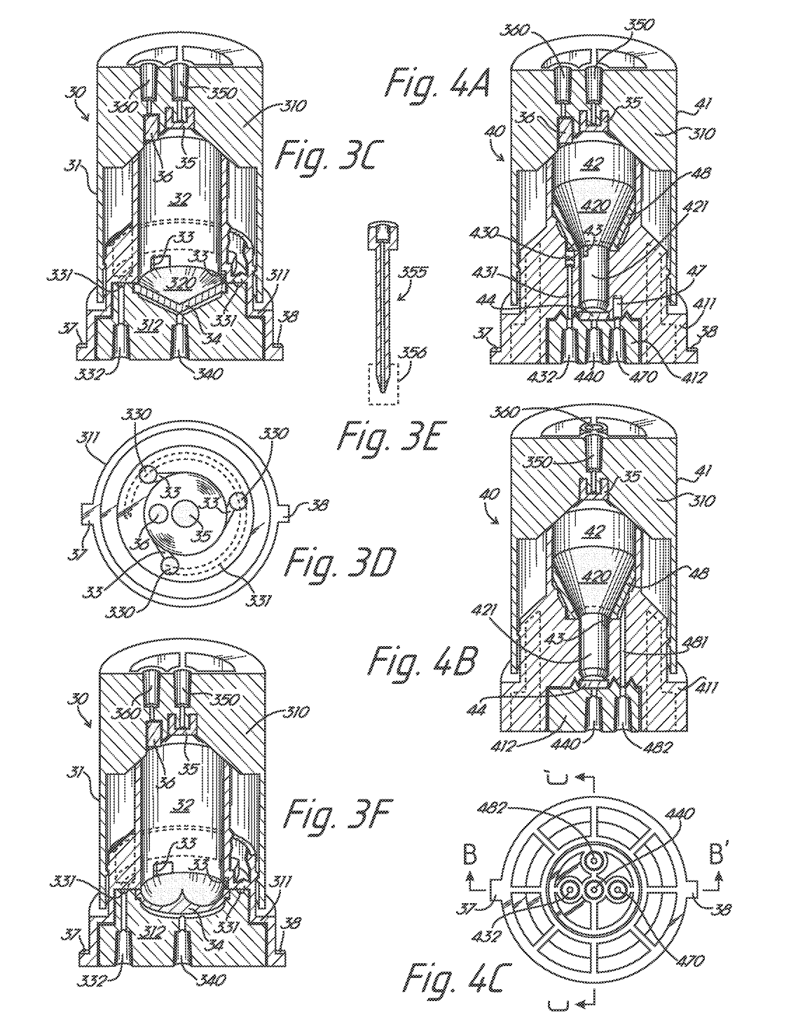

Referring to FIGS. 3A to 3D, first dissolution testing cell 30 is constructed for use in simulating, in an in vitro setting, one or more local hydrodynamic dissolution conditions of an in vivo dissolution process.

First dissolution testing cell 30 (FIGS. 3A to 3D) comprises: body 31 defining cell cavity 32; a plurality of tangentially oriented (hereinafter, tangential) openings consisting of three tangential openings to the cell cavity, two of which are visible at 33 in the front sectional view in FIG. 3C; and a conical filter 34 disposed at one end of the cell cavity, functioning as a bottom wall thereof and a bottom opening thereto. Cell cavity 32 has an axially symmetric shape with two ends and a side wall (FIG. 3C). Each of the tangential openings 33 is disposed on the side wall of the cell cavity 32 at one end thereof, and spaced apart substantially evenly one from another of the tangential openings. Each of the tangential openings (33) is further in a form of a nozzle having a generally rectangular orifice. A said nozzle is aimed in a direction substantially tangential to the (circular) side wall of the cell cavity (FIG. 3D, further description below) when viewed in a horizontal sectional view. The tangential openings 33 are in fluid communication with a fluid connection port 332, via a fluid distribution channel 331 (FIG. 3C). Bottom opening 34 is in fluid communication with another fluid connection port 340. Conical filter 34 defines a conical end 320 of cell cavity 32.

In the presently shown construction of first dissolution testing cell 30, body 31 is formed as an assembly of three parts 310, 311, and 312 (FIG. 3C), each of which is formed of a plastic material by way of injection molding. Parts 311 and 312 are permanently affixed together by, in the present embodiment, solvent welding, and, in combination, form structural portion of a base half of first dissolution testing cell 30. Part 310 forms a cap therefor. Referenced at 315 in FIG. 3A are broken line illustrations indicating interior (hidden) rib structures customary to the art of injection molded plastics. Non-referenced rib structures visible in the bottom plan view of body 31 in FIG. 3B are apparent without further elaboration. 37 and 38 are structures for alignment use.

A full view of all of the three tangential openings 33 can be seen in the interior bottom plan view of body 31 in FIG. 3D (part 311 being visible therein and part 310 being hidden behind part 311), after part 312 is removed, exposing bottom surface of part 311. Also visible in FIG. 3D are filters 330 (small, cylindrically shaped in the present embodiment) placed between nozzle (i.e. tangential opening) 33 and fluid distribution channel 331 (FIG. 3C). The latter, as illustrated in FIG. 3C, is formed between parts 311 and 312, as a groove formed into top surface of part 312. In FIG. 3D, position of the groove (i.e. fluid distribution channel) 331 relative to nozzles 33 is indicated by broken line illustration 331 superimposed on the interior bottom plan view.

In the presently shown construction of first dissolution testing cell 30, a major portion of cell cavity 32 has the shape of a cylinder and the other end of cell cavity 32 has a conical shape in substantial mirror image to end 320.

In the presently shown construction, first dissolution testing cell 30 further comprises a third opening 35 fitted with a filter and a fourth opening 36 fitted with a filter (FIGS. 3A, 3C and 3D). Third opening 35 is in fluid communication with fluid connection port 350 and fourth opening 36 fluid connection port 360.

A needle shaped sampling or extension probe 355 is illustrated in the front sectional view in FIG. 3E. The probe 355 may be used in place of third opening 35 (FIG. 3C) to allow extension of third opening 35 to tip 356 of the probe 355. Where desired, a filter may be fitted onto the tip 356 (FIG. 3E).

Accessories such as small beads for the simulating of food effect, and a rubber-surfaced piston to fit into 32, driven by pressurized inert gas from 350 and/or 360 to simulate a gut wall, may be included (not drawn).

Various advantageous features of first dissolution testing cell 30 will be seen from the following description of various modes in which first dissolution testing cell 30 is used in accordance with embodiments of the invention in testing a sample of a solid dosage product in determining a property of dissolution of an ingredient thereof under one or more hydrodynamic dissolution conditions, especially a discrete fluidization and settlement hydrodynamic dissolution condition. The description pertains to the sample as a falling solid; certain modifications, e.g., a reversing of vertical orientation of the dissolution testing cell in certain situations, will occur to those skilled in the art taught by the present disclosure, when the sample is a rising, i.e., floating, solid.

Referring to FIG. 3C, in a first mode of using first dissolution testing cell 30, a sample, such as a disintegrating, immediate release pharmaceutical tablet, having a disintegrated volume less than that which would reach to cover a tangential opening 33 upon particulates of the sample settling into, in a rotationally moving (see description below) column of dissolution medium, a cone-shaped pile on bottom wall of cell cavity 32, by gravity, is placed in cell cavity 32 of the base half of the first dissolution testing cell 30. Use of cap 310 is optional. Fluid conduits are connected to ports 332 and 340. Fluid flow via port 340 is stopped. A pulse of dissolution medium of a precisely known volume about three (3) to fifteen (15) preferably about five (5) to ten (10) times the disintegrated volume of the solid dosage sample is allowed to enter cell cavity 32 via nozzles 33, at a controlled flow rate and controlled velocity. The controlled flow rate may be a constant flow rate or a time-programmed, gradient flow rate, designed to provide a constant or a time-programmed, gradient rate of upward flow, respectively, in cell cavity 32 during the pulse. At a sufficiently high rate of the upward flow with vertical linear velocity greater than vertical velocity of fluidization of a particulate of the sample, the pulse forms a fluidizing period of a discrete fluidization and settlement hydrodynamic dissolution condition for the particulate. Vertical linear velocity of the upward flow and volume of the pulse, in combination, determine dᵥ (i.e., linear vertical distance of dissolution medium flow per unit time) for a particulate of a given vertical velocity of fluidization. At the end of the fluidizing period, i.e., as the vertical linear velocity of the pulse drops to zero, or gradually decreases following a gradient to less than vertical velocity of fluidization of a particulate, a period of settling follows. Thereafter, a period of no flow and thus zero vertical linear velocity of upward dissolution medium movement, or a low flow rate and thus less than the vertical velocity of fluidization, provides a resting period or a period of pressure-sensitive packed bed hydrodynamic dissolution condition, respectively. A sample of clear dissolution medium in cell cavity 32 is then taken via tangential opening 33 or probe 355 to determine amount of an ingredient dissolved therein for computation of differential rate of dissolution of the ingredient. Where concentration of a dissolved ingredient is within an appropriate range to allow direct and accurate fiber optic UV-Visible spectrophotometric determination in situ, a fiber optic UV-Visible cell may be installed in cell cavity 32, so long as the UV-Visible cell causes no significant disturbance of the discrete fluidization and settlement hydrodynamic dissolution condition.

It is noted that, at the end of the fluidizing period and the start of the settling period, dissolution medium in cell cavity 32 continues (but gradually decreases in angular velocity, and eventually reaches zero) its horizontally rotational movement because of momentum. The continued rotational movement causes particulates of the sample to settle into a cone-shaped pile on bottom wall of cell cavity 32.

Because part of a horizontally rotational movement in a circularly shaped cell cavity 32 turns into, or causes, a vertical component of dissolution medium flow, dᵥ cannot be calculated exactly from, but may be approximated by, height of water column of dissolution medium in cell cavity 32. Given a dissolution testing cell 30 and discrete fluidization and settlement dissolution condition, dᵥ can, however, be calibrated by a standard solid of a known vertical velocity of fluidization and rate of dissolution.

A second mode of use differs from the first mode of using first dissolution testing cell 30 in that, during a fluidizing period of a discrete fluidization and settlement hydrodynamic dissolution condition, dissolution medium enters cell cavity 32 via bottom opening 34 instead of tangential openings 33, and flow via tangential openings 33 during the period is stopped. This mode of use, while it allows the testing of dissolution of a sample under a discrete fluidization and settlement hydrodynamic dissolution condition in accordance with an embodiment of the invention, is, however, experimentally found to suffer from noisy test results, presumably due to horizontally non-uniform upward flow and/or poor mixing of dissolution medium, in cell cavity 32, during and/or by the end, respectively, of a cycle of discrete fluidization and settlement. Accordingly, the second mode of use is not preferred.

A third mode of use differs from the first in that, during a fluidizing period, both ports 332 and 340 are connected to a common source of dissolution medium, which enters cell cavity 32 via both the tangential openings 33 and the bottom opening 34 at the same time during the fluidizing period.

A fourth mode of use differs from the third in that, during a fluidizing period, each of ports 332 and 340 is connected to an independently controlled source of dissolution medium, at an independently controlled flow rate. An independently controlled source of dissolution medium entering cell cavity 32 via tangential openings 33 by way of port 332 controls a tangential and horizontal component of velocity of movement of dissolution medium in cell cavity 32. An independently controlled source of dissolution medium entering cell cavity 32 via bottom opening 34 by way of port 340 controls a vertical component of the velocity. By way of independently controlling the components of velocity, a variety of local hydrodynamic dissolution conditions with a variety of local fluid velocities, controlled both in amplitude and in spatial direction, may be formed in cell cavity 32 of first dissolution testing cell 30.

A fifth mode of use allows first dissolution testing cell 30 to be of utility in the determining of rate of dissolution of an ingredient of a solid dosage product under a discrete settlement hydrodynamic dissolution condition. In such a mode of use, a sample is placed at bottom (320) of cell cavity 32, ports 340 and 360 are closed, and dissolution medium enters cell cavity 32 from tangential openings 33 by way of port 332, displacing trapped air out of cell cavity 32 via top opening 35 by way of port 350 until the dissolution medium fills up cell cavity 32. Port 350 is then closed. Reversing of vertical orientation of cell 30 allows half of a cycle of discrete settlements, in which the sample settles by gravity towards the currently shown top end (filter 35, FIG. 3C). Reversing again and returning of vertical orientation of cell 30 to the currently shown (FIG. 3C) allows the other half of the cycle in which the sample re-settles by gravity towards the currently shown bottom end (bottom filter 34, FIG. 3C). A sample of clear dissolution medium is withdrawn from cell cavity 32 via a choice or combination of tangential openings 33, third opening 35, and fourth opening 36, before dissolution medium in cell cavity 32 is completely drained out via bottom filter 34, readying the sample for a next cycle of testing. Concentration of an ingredient dissolved in the sample withdrawn is determined for computation of differential rate of dissolution of the ingredient during the cycle. The dissolution medium completely drained out of cell cavity 32 is accumulated in a cumulative vessel and combined with any dissolved amount of the ingredient during the dissolution test prior to the cycle. Mass of the ingredient dissolved in dissolution medium accumulated in the cumulative vessel is then determined for computation of cumulative mass of the ingredient dissolved as of a time during the cycle or thereabout (e.g., during, at the beginning, or at the end thereof).

A sixth mode of use allows first dissolution testing cell 30 to be of utility for the determining of rate of dissolution of an ingredient of a solid dosage product under a pressure-sensitive packed bed hydrodynamic dissolution condition of a low head pressure. In such a mode of using the cell, a sample is placed at bottom (320) of cell cavity 32, cap 310 is optional, port 340 is initially closed, a known volume of dissolution medium gently enters cell cavity 32 via tangential openings 33, as a stream of a controlled (low) flow rate, allowing the sample to maintain as a pile (i.e., a packed bed) on bottom wall of cell cavity 32. A sample of the dissolution medium in cell cavity 32 is taken via tangential openings 33 for determination of differential rate of dissolution before the dissolution medium is completely drained out of cell cavity 32 via bottom opening 34, readying the sample for a next cycle of testing. The dissolution medium completely drained out is accumulated for determination of cumulative mass dissolved.

By way of a time-programmed control of rates of flowing dissolution medium into cell cavity 32 via the tangential openings 33, the bottom opening 34, or a combination thereof, a time-programmed local hydrodynamic dissolution condition is formed for experimentally simulating a time course of a complex hydrodynamic dissolution condition of a complex in vivo dissolution process.

A modified first mode of use further comprises, in a cycle of discrete fluidization and settlement, a pulse of dissolution medium of a known volume (about the volume of 320) entering cell cavity 32 via bottom filter 34 before the pulse of dissolution medium entering via nozzles 33.

It will, of course, be apparent to those skilled in the art, taught by the present disclosure, that more than one of the above described modes of use may be programmed into a single dissolution test as a time series of cycles each cycle consisting of a time series of the more than one different modes (dissolution conditions), and more than one rate functions determined from the single test, each under a different dissolution condition (other than dissolution medium contact time) of a single dissolution process.

While end wall of cell cavity 32 of first dissolution testing cell 30 illustrated in FIG. 3C has a conical shape in the presently described embodiment of the invention, in other embodiments, the end wall may have other shapes, such as flat, round, and flat or round with a central rise (e.g., FIG. 3F).

The data presented in FIGS. 1A and 1B were determined by using a prototype dissolution testing cell similar to first dissolution testing cell 30 (FIG. 3C), except that bottom of cell cavity (32) was flat, bottom filter (34) and associated fluid connection (340) absent, and one tangential opening with a circular nozzle in place of three (33) each with the rectangular nozzle. Diameter of cylindrically shaped cell cavity (32) of the prototype dissolution testing cell was 2.15 centimeters. Each cycle of discrete fluidization and settlement had duration of 2 minutes, except the first cycle. The first cycle in determining the curve 10 data had duration of 5 minutes and the curve 12 data 10 minutes. A beginning 3 seconds of each cycle consisted of a fluidizing period, and the remaining a settling and a resting period. A total volume of 8.04 milliliters of dissolution medium was delivered at a constant flow rate to the tangential nozzle during a fluidizing period, achieving a vertical velocity of dissolution medium flow in cell cavity 32 calculated at an average value of about 0.74 centimeter/second. Treating the longer duration of the first cycle as a combination of a regular cycle (i.e. one of the subsequent cycles) plus 3 minutes and 8 minutes of extra disintegration time under a static hydrodynamic condition for curve 10 and 12, respectively, dᵥ for each regular cycle is calculated at 1.1 centimeter/minute. Sampling of dissolved acetaminophen in each cycle was achieved by means of a probe (355, without filter tip 356) immediately before a next cycle began. Each sample of solution consisted of 8.04 milliliters except in the first cycle. The sample in the first cycle was about 7 milliliters (so there was about 1 milliliter of dead volume of solution in the cell cavity after each sampling). Each sample of solution was filtered (WHATMAN 0.45 micrometer GMF) immediately after sampling before being stored away for UV determination (within 12 hours). First 4 milliliters or so of a filtrate was discarded. Concentration of acetaminophen dissolved in each sample of solution was determined by UV at 242 nanometer. Mass dissolved during each cycle was computed as product of multiplication of the concentration, and volume (8.04 milliliters) of dissolution medium of each cycle. Dividing the mass by duration (2 minutes) of a cycle gives differential rate of dissolution during the cycle. Dividing the differential rate of dissolution by dᵥ gives mass of acetaminophen dissolved per unit linear vertical distance of local dissolution medium flow.

While in the FIG. 1A embodiments r(t) is experimentally determined, M(t) computed therefrom, and r(M) subsequently constructed from r(t) and M(t), it is preferred that, in other preferred embodiments (see, e.g., description of the fifth and sixth modes of using first dissolution testing cell 30 above), r and M are determined independently one from the other, pair-wise, at or about each point of a plurality of points of time representative of a dissolution process or dissolution condition, or averaged over each interval of a plurality of intervals of the time, each of the intervals being non-overlapping with another. The plurality of points of time or non-overlapping intervals being representative of the dissolution process, an r(M) function constructed directly from pair-wise experimentally determined values of r and M characterizes dissolution of an ingredient in the dissolution process. The plurality of points of time or non-overlapping intervals being all under a given dissolution condition, the r(M) function constructed characterizes dissolution under the given dissolution condition.

Determining an r(M,t_{c}) function at a given small value of M (e.g., zero percent of labeled mass dissolved) and varying values of t, for a solid dosage product dissolving in a fluidized state (e.g., under a discrete fluidization and settlement hydrodynamic dissolution condition), allows the r(M,t_{c}) function to provide information on rate of disintegration of a disintegrating tablet or rate of dissolution of a tablet coating.

Referring now to FIGS. 4A to 4C, second dissolution testing cell 40 in a preferred embodiment of the invention comprises a same cap 310 (FIG. 4A) as first dissolution testing cell 30 (FIG. 3C), and differs therefrom in a base half (411 plus 412) of body 41 (FIGS. 4A and 4B). The base half (411 plus 412) of body 41 defines cell cavity 42, and comprises: first tangential opening 43 (FIGS. 4A and 4B); second tangential opening 47 (FIG. 4A); bottom filter 44; and side wall filter 48. Cell cavity 42 has an axially symmetric shape as in first dissolution testing cell 30, and differs therefrom in that it (42) comprises a truncated conical section 420 and a bottom cylindrical section 421. Side wall of truncated conical section 420 is defined by side wall filter 48. 48 is in fluid communication with fluid connection port 482 via passageway 481 (FIG. 4B), providing a side opening to cell cavity 42. First tangential opening 43 is in fluid communication with fluid connection port 432 via cylindrical filter housing 430 (the filter housed therein is not drawn in order to show the housing) and passageway 431 (FIG. 4A). Second tangential opening 47 is in fluid communication with fluid connection port 470 (FIG. 4A). Bottom filter 44 is in fluid communication with fluid connection port 440 (FIGS. 4A and 4B). As seen in FIGS. 4A and 4B, first tangential opening 43 is disposed at an upper end of cylindrical section 421. As seen in FIG. 4A, second tangential opening 47 is disposed at a lower end thereof. Each of the tangential openings 43 and 47 comprises a nozzle oriented tangentially to (circular) side wall of cylindrical section 421 and, when viewed top down, one in a one-hundred-eighty (180) degree rotational relationship to the other. Each nozzle provides a tangential opening to cell cavity 42. The bottom filter 44 provides a bottom opening thereto. In FIG. 4A, the nozzle of second tangential opening 47 is out of the cross-section plane and thus out of the cross-sectional view. Seen at 47 is more precisely a cylindrical filter housing of second tangential opening 47 visible in FIG. 4A (the filter housed is not drawn in order to show the housing), equivalent to housing 430 of first tangential opening 43.

Second dissolution testing cell 40 is advantageously constructed for use in the testing of rate of dissolution of a plurality of particulates under a discrete fluidization and settlement hydrodynamic dissolution condition in a manner similar to the second, third, fourth, fifth, and modified first modes of using first dissolution testing cell 30. In such a mode of use, a multi-particulate (e.g., powder) or a disintegrating solid dosage form (e.g., a disintegrating pharmaceutical tablet), or a sample thereof consisting of a plurality of particulates, having a disintegrated wet volume not to exceed the level of nozzle of tangential opening 43 when settled to bottom of cell cavity 42 by gravity, preferably about one half (½) to about two thirds (⅔) of volume of cylindrical section 421, is placed in the cell cavity 42 for testing.

Second dissolution testing cell 40 is advantageously constructed for use further in the testing of rate of dissolution of a plurality of particulates under a pressure-sensitive packed bed dissolution condition at a precisely measured head pressure (i.e. pressure drop across a packed bed), and for the determining of hydraulic conductivity or resistance of particulates. In such a use, fluid connection ports 360 and 350 are closed, cell cavity 42 is completely filled with dissolution medium (e.g., by way of side opening 48 and port 482, removing any trapped air from top opening 35 and port 350 before port 350 is closed), a differential pressure transducer is connected to fluid connection ports 470 and 432, a plurality of particulates allowed to settle, and be packed into a packed bed, in cylindrical section 421, port 482 connected to a dissolution medium supply, and port 440 allows dissolution medium to exit from cell cavity 42.

To test rate of dissolution of the plurality of particulates under a pressure-sensitive packed bed dissolution condition in accordance with one embodiment of the invention, dissolution medium is supplied through 482 and allowed to pass through the bed of particulates in cylindrical section 421 at a given or known flow rate, while pressure drop between tangential openings 43 and 47 is read. Concentration of an ingredient dissolved in dissolution medium exiting 440 is determined. Rate of dissolution rₚ(M,t_{c}) as a function of M and t_{c} is computed by:

rₚ(M,t_{c})=Q·C(M,t_{c}) (30.)

where C(M,t_{c}) is concentration of dissolved ingredient in dissolution medium exiting 440, determined when cumulative mass dissolved is M and dissolution medium contact time is t_{c}; and Q volumetric flow rate of the dissolution medium exiting 440.

Specific hydraulic conductivity ω is computed by:

$$ω = \frac{L \cdot Q}{A \cdot Δ P} \qquad ( 31. )$$

where A is cross-sectional area of cylindrical section 421; L height of sample packed therein; and ΔP pressure drop. L and ΔP may be determined as a function of M and t_{c}.

Specific hydraulic resistance σ is a reciprocal of specific hydraulic conductivity:

σ=1/ω (32.)

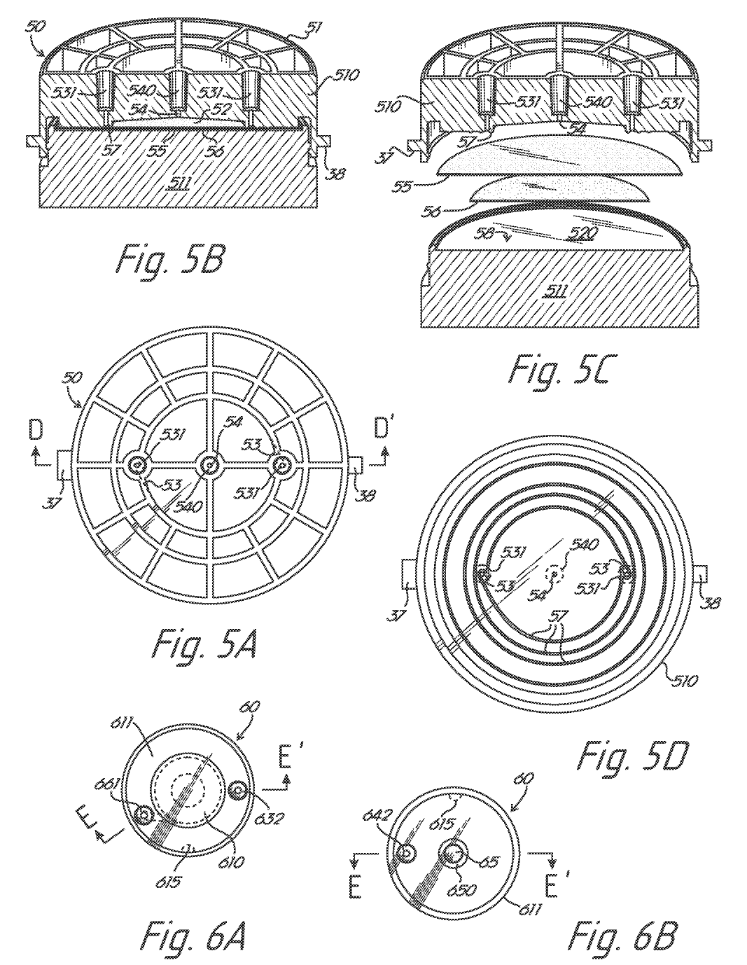

Referring now to FIGS. 5A to 5D, third dissolution testing cell 50 is constructed for use in the testing of rate of dissolution of a solid ingredient of a transdermal patch. Third dissolution testing cell 50 comprises: body 51 consisting of base 511 and cap 510 in an assemblage (front sectional view of the assemblage in FIG. 5B, and exploded view in FIG. 5C); cell cavity 52 defined by body 51 (FIG. 5B); two tangential openings 53 (as hidden structure shown by broken line illustration in top plan view in FIG. 5A and visible in bottom plan view of cap 510 in FIG. 5D) to cell cavity 52; a center opening 54 to same; and a membrane 55. Cell cavity 52 has an axially symmetrical shape and a minimal height, the shape being substantially represented by that of a disc. Each of the two tangential openings 53 is in a form of a nozzle disposed on side wall of the cell cavity 52 and oriented in a tangential direction thereto, one in a one hundred eighty (180) degree rotational relationship to the other. Each of the two tangential openings 53 is in fluid communication with a fluid connection port 531 (FIGS. 5A to 5D). The center opening 54 is in fluid communication with a fluid connection port 540. Membrane 55 may be a membrane filter of a known porosity and thickness, a skin tissue, a biological membrane, or an artificial membrane which simulates a skin tissue or biological membrane.

In an in vitro dissolution test using cell 50, transdermal patch 56 is patched to one side of membrane 55, the patched membrane is placed with the patch down on top of top surface 58 of base 511, and cap 510 is placed on top of the patched membrane, sandwiching same between cap 510 and base 511. Sufficient pressure is applied to enable cap 510 to press against base 511 allowing cavity 52 to be formed as a fluid-tight cavity sealed at peripheral edge by sealing rings (ridges formed on bottom surface of cap 510, FIG. 5D, indicated at 57). Dissolution medium is supplied at a known flow rate to cell cavity 52 via tangential openings 53 by way of fluid connection ports 531, and allowed to exit therefrom via center opening 54 by way of fluid connection port 540. Concentration of an ingredient dissolved in dissolution medium exiting from the cell cavity is determined, as is cumulative mass of the ingredient dissolved therein. Rate of dissolution as a function of, at least, cumulative mass dissolved is computed in a manner similar to that using equation (30.).

Third dissolution testing cell 50 may also be used for the testing of rate of dissolution or release of such solid or semi-solid dosage forms as creams and pastes. In such a use, a sample such as a paste is applied (i.e., spread) as a thin layer evenly to top surface 58 of base 511, filling up shallow well 520 (lower cell cavity). Membrane 55 is placed on top of the thin layer and cap 510 on top of the membrane, closing the cell. Remaining steps are as in testing a patch described above. Alternative to applying the sample to top surface 58 is applying the sample directly to undersurface of membrane 55.

A smaller version of the third dissolution testing cell for testing a small amount of material, e.g., a pure solid, will be apparent to those skilled in the art taught by the present disclosure. Surface 58 may be coated or lined with a water-proofing material (e.g., silicone). If lined, a venting hole may be provided on 58.

Turning now to FIGS. 6A to 6C, fourth dissolution testing cell 60 is constructed for use in the determining of vertical velocity of fluidization of a dissolving particulate and for the determining of rate of dissolution under a discrete settlement hydrodynamic dissolution condition. Fourth dissolution testing cell 60 comprises: body 61 consisting of base 610 and cap 611 in an assemblage (shown upside down in a reversed orientation in FIG. 6C); cell cavity 62 defined by body 61; first ring opening 63 to cell cavity 62; second ring opening 64 thereto; end opening 65 thereto; and tangential opening 66 thereto. Cell cavity 62 has a vertically elongated shape comprising a main section 620, an analytical section 621, and two end sections 623 and 625. In the presently shown and described preferred embodiment, each of the sections is axially symmetric with regard to a common axis of symmetry. End section 623 and 625 each comprise a tapered shape and a nipple space for centering and focusing a particulate sample. First ring opening 63 is in a form of a ring filter disposed at one end of main section 620 as shown (FIG. 6C). Second ring opening 64 is in a form of a ring filter disposed about one centimeter apart (along the axis of symmetry) from first ring opening 63. End opening 65 is in a form of a substantially disc-shaped filter disposed at one end of cell cavity 62, one side of the filter forming an end wall thereof Tangential opening 66 is in a form of a nozzle disposed on side wall of the cell cavity 62, and oriented in a tangential direction thereto, at an end of main section 620 opposing the end at which first ring opening 63 is disposed. First ring opening 63 is in fluid communication with fluid connection port 632 via distribution channel 630. Second ring opening 64 is in fluid communication with fluid connection port 642 via distribution channel 640. End opening 65 is in fluid communication with fluid connection port 650. Tangential opening 66 is in fluid communication with fluid connection port 661. Section 620 in the presently shown and described embodiment has a length (along the axis of symmetry) of about twelve (12) centimeters, which in equivalent embodiments may be longer or shorter (for a particulate having a higher or lower vertical velocity of fluidization, respectively) to allow accurate measurement of time of settlement of a particulate settling from end 625.

In use, base 610 is placed in a (normal) vertical orientation reversed from that shown in FIG. 6C and a particulate sample placed in opening 625 thereof Cap 611 is then placed on base 610 (i.e., base 610 is plugged into opening of cap 611), forming a fluid-tight combination therewith sealing at 67. While the normal vertical orientation is maintained, a stream of dissolution medium is directed to fluid connection port 661 from which it enters into cell cavity 62 via tangential opening 66. The stream of dissolution medium is allowed to fill up the volume of cell cavity 62 and displace any fluid content including trapped air therein. A stream of dissolution medium is then directed to fluid connection ports 632 and 642, entering cell cavity 62 via ring openings 63 and 64, leaving therefrom via end opening 65, and expelling any trapped air along the way. Thereafter, while a steady flow of dissolution medium entering into cell cavity 62 via ring opening 63 and fluid connection port 632, and leaving therefrom via ring opening 64 and fluid connection port 642, thereby creating a cross flow in analytical section 621, is maintained at a known flow rate, the dissolution cell 60 is flipped over to a reversed vertical orientation (as is shown in FIG. 6C), allowing the particulate sample to settle by gravity in a column of dissolution medium in cell cavity 62. As a dissolving particulate reaches and passes analytical section 621, dissolution of the particulate occurs in the cross flow and solute therein is carried by the cross flow to fluid connection port 642. The latter (642) is connected to a detector allowing detection of the solute in the cross flow and thereby an amount of time the particulate took to settle from end section 625 to analytical section 621.

Reversing of the vertical orientation of cell 60 to the normal vertical orientation and the allowing of full settlement of undissolved particulates to end section 625 readies the sample for a next cycle of steps of the displacing of fluid content in cell cavity 62 and the determining of time of settlement of undissolved particulates thereby vertical velocity of fluidization. Determination of cumulative mass of an ingredient dissolved from the particulates in effluent from cell cavity 62 allows the time of settlement or vertical velocity of fluidization to be expressed as a function of, at least, cumulative mass of the ingredient dissolved.

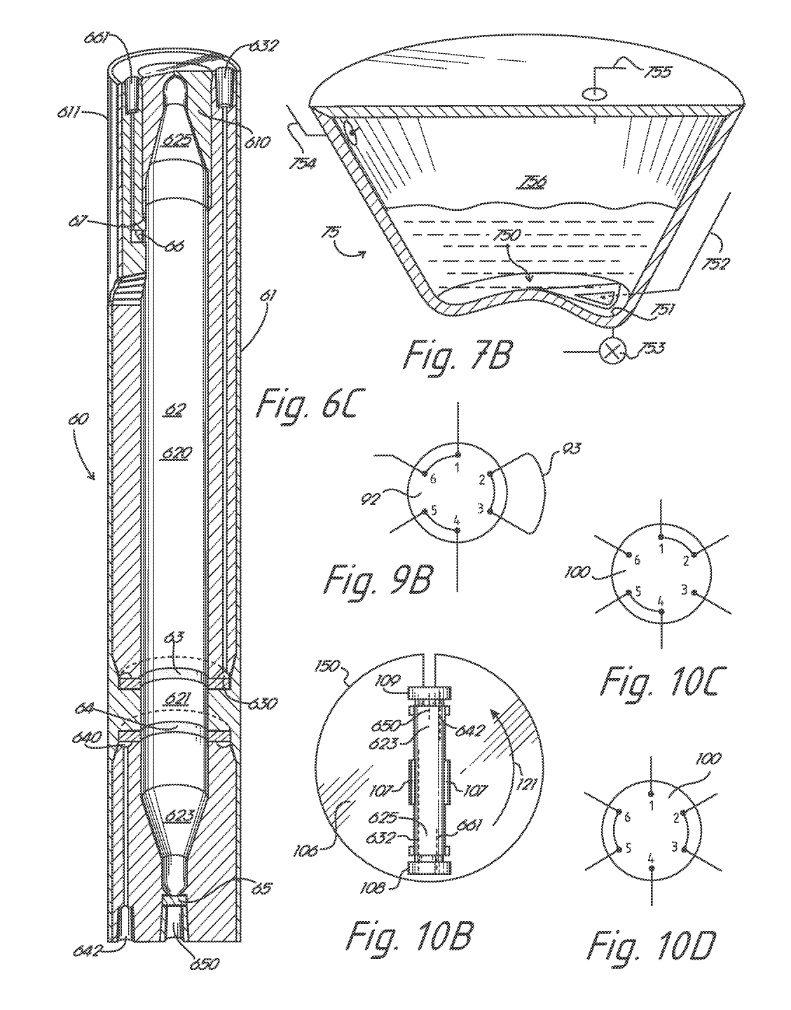

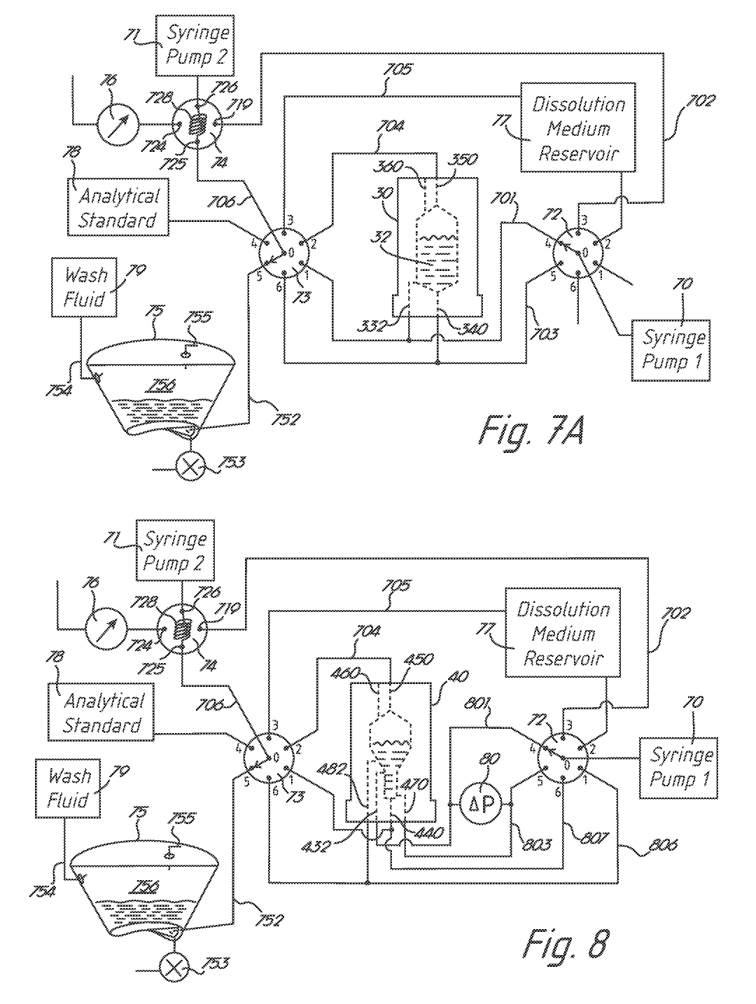

Referring now to FIG. 7A, the schematic diagram therein shows fluidics and combination of functional components of the first dissolution testing apparatus in use with the first dissolution testing cell 30 in an automated determination of differential rate of dissolution of an ingredient of a solid dosage product as a function of, at least, cumulative mass of the ingredient dissolved therefrom, under one or more hydrodynamic dissolution conditions. The functional components of the first dissolution testing apparatus comprise: syringe pump “1” 70; syringe pump “2” 71; first multi-port selection valve 72; second m selection valve 73; sampling valve 74; cumulative vessel 75; and fluid conduits illustrated by solid line connections, some of which are referenced as shown (701, 702, 703, 704, 705, and 706, hereinafter sometimes, interchangeably, fluid connection lines or simply fluid lines). Referenced at 76 is a detector for flow injection analysis (FIA), 77 a dissolution medium reservoir, 78 analytical standard for calibration of detector 76 (or calibration check thereof), and 79 a source of wash fluid for use in the cleaning of cumulative vessel 75 in between dissolution tests. Dissolution testing cell 30, including its various fluid connection ports, is as described in detail herein before and illustrated in FIGS. 3A to 3E. A more detailed view of cumulative vessel 75 is shown in FIG. 7B, and sampling valve 74 in FIGS. 7C to 7F. Relation of one of the functional components to another is as depicted in FIG. 7A and will be further understood from the following description of use of the apparatus.

Use of the apparatus in the modified first mode of using dissolution testing cell 30 is described below as an example in detail. A sample of the solid dosage product is placed in cell cavity 32 (FIG. 7A, more details in FIG. 3C) of dissolution testing cell 30. Upon closing, the dissolution testing cell 30 is connected to fluid conduits of the dissolution testing apparatus by way of the cell's fluid connection ports, as schematically illustrated in FIG. 7A. First multi-port selection valve 72 is switched to port “2” (i.e., connecting of port “0” to port “2”, FIG. 7A) and syringe pump “1” 70 withdraws a volume of dissolution medium from dissolution medium reservoir 77. First multi-port selection valve 72 is then switched to port “5” and syringe pump “1” 70 discharges, to fluid connection port 340 of dissolution testing cell 30, a first known volume of dissolution medium equal to about volume of the conical end 320 of cell cavity 32 (FIG. 3C), as a stream at a first controlled flow rate Immediately afterwards, first multi-port selection valve 72 is switched to port “4” (as is presently shown in FIG. 7A) and syringe pump “1” 70 discharges, to fluid connection port 332 of dissolution testing cell 30, a second known volume of dissolution medium, as a stream at a second controlled flow rate programmed or set to provide a continued upward dissolution medium flow in cell cavity 32, while at the same time causing a rotational component of movement of the dissolution medium therein. While first multi-port selection valve 72 selects ports “5” and “4”, and syringe pump “1” 70 discharging, second multi-port selection valve 73 selects port “5” (as is presently shown in FIG. 7A), sampling valve 74 in a sampling position (in which sample loop, 728, is placed in between ports 725 and 726, FIG. 7A, and connects therebetween, as is presently shown), and syringe pump “2” 71 withdraws a volume of contents of cumulative vessel 75, which, as will be described below, accumulates dissolution medium exiting from cell cavity 32 of dissolution testing cell 30 during a dissolution test. A period of no inward dissolution medium flow into cell cavity 32 (i.e., a period of discrete settlement) allows fluidized particulates of the sample to settle to bottom of cavity 32. During this period (of discrete settlement), first multi-port selection valve 72 is switched to port “3”, sampling valve 74 to an analyzing position (in which sample loop, 728, is placed in between ports 724 and 719, FIG. 7A, and connects therebetween), and syringe pump “1” 70 discharges a steady stream of dissolution medium as part of (see further description below) a carrier solvent for flow injection analysis (FIA), to port 719 via fluid conduit 702, sending contents of sample loop 728 to detector 76. At the end of the period of discrete settlement, second multi-port selection valve 73 is switched to port “1”, sampling valve 74 back to the sampling position, and syringe pump “2” 71 withdraws dissolution medium from cell cavity 32 via fluid connection port 332 and tangential openings 33 (FIG. 3C), allowing the dissolution medium withdrawn to be sampled by sample loop 728. Sampling valve 74 is then switched again to the analyzing position and, while first multi-port selection valve 72 maintains selection of port “3”, syringe pump “1” 70 discharges again a steady stream of dissolution medium as FIA carrier solvent to port 719 via fluid conduit 702, sending contents of sample loop 728 to detector 76. Next, second multi-port selection valve 73 is switched to port “6”, sampling valve 74 back to the sampling position, and syringe pump “2” 71 completely withdraws dissolution medium out of cell cavity 32 via bottom opening 34 and fluid connection port 340 (FIG. 3C). Next, second multi-port selection valve 73 is switched to port “5”, and syringe pump “2” 71 discharges it entire contents to cumulative vessel 75. While syringe pump “2” 71 discharges its entire contents, the steps described above begin to repeat, to a completion of dissolution of the ingredient of the sample. An exception to repeated cycles of the steps described above is the first and the second cycles thereof, at the beginning of a dissolution test. In the first cycle thereof, a step of withdrawing from analytical standard reservoir 78 via port “4” of the second multi-port selection valve 73 replaces the step of withdrawing from an (empty) cumulative vessel 75 via port “5”. In the second cycle thereof, a step of withdrawing from dissolution medium reservoir 77 via port “3” of the second multi-port selection valve 73 by way of fluid conduit 705, replaces the step of withdrawing from the cumulative vessel 75, which, at the end of the first cycle, contains dissolved ingredient the concentration of which is known from the first cycle. The step of withdrawing from dissolution medium reservoir 77 provides a blank FIA data point, for checking, e.g., any carry over error of the FIA.

It will be seen from the schematic diagram shown in FIG. 7A that in the present embodiment of the invention syringe pump “2” 71 is also allowed to withdraw content of cell cavity 32 of dissolution testing cell 30 from port 350 of the dissolution testing cell, via fluid conduit 704, by way of port “2” of second multi-port selection valve 73, the dissolution testing cell 30 comprising a sampling probe 355 shown in FIG. 3E and described herein before. Fluid connection port 360 may be left open to atmosphere, closed, or connected to a valve-controlled source of inert gas (such as nitrogen). The latter may be pressurized and, under valve control, used to pressurize cell cavity 32 during the withdrawing of contents thereof by syringe pump “2” 71, to facilitate (as a secondary, pneumatic pump) the withdrawing, in a dissolution test.

A programmable microprocessor controller (not shown in the drawings) controls motors that drive the syringe pumps (e.g., 70), the multi-port selection valves (e.g., 73), the sampling valve (74), and various ancillary valves such as 753. Various flow schemes may be programmed into a dissolution test by way of the programmable microprocessor controller, including various values of the first and the second known volume described above, their controlled flow rates including any gradient of the second controlled flow rate, and various sequences or orders of flow events. See description on modes of using dissolution testing cell 30 hereinbefore.

Ports “1” and “6” of first multi-port selection valve 72 (FIG. 7A) in the present embodiment of the invention are currently spare ports not in use. For a multi-media (two or more media) dissolution test involving, e.g., an acid stage and a neutral stage, in testing, e.g., an enteric coated pharmaceutical tablet, the spare ports can be connected to a second and a third dissolution medium reservoir, respectively, and programmed for automatic change of dissolution medium during the dissolution test.

Cumulative vessel 75 may be of any design suitable for the purpose of use thereof described above. In the present preferred embodiment of the invention, cumulative vessel 75 is of an inventive design described and shown in more detail below and in FIG. 7B.

Referring to FIG. 7B, cumulative vessel 75 comprises vessel cavity 756 having an axially symmetric shape (in the present preferred embodiment, reversed cone-shape) except bottom 750. Bottom 750 is a surface which spirals down to a lowest point 751 in one full turn of three-hundred-sixty (360) degrees. To the lowest point 751 are fitted an inlet for incoming dissolution medium (coming from, e.g., dissolution testing cell 30) during a dissolution test, and an outlet for complete drainage of accumulated dissolution medium and any washing fluid used to clean the cavity 756, at the end of a dissolution test. Fluid line 752 directs incoming dissolution medium entering vessel cavity 756 in a direction tangential to circular side wall thereof, at the lowest point 751, causing dissolution medium in cavity 756 to swirl for mixing with the incoming dissolution medium, and allowing syringe pump “2” 71 to sample even a small volume of dissolution medium accumulated in vessel cavity 756 at an early stage of a dissolution test. Vessel cavity 756 may be a gas-tight space connected to a valve-controlled source of pressurized inert gas such as nitrogen through fluid connection line 755, pressure from the pressurized inert gas facilitating the sampling of dissolution medium in vessel cavity 756 by syringe pump “2” 71. Fluid line 754 directs wash fluid entering vessel cavity 756 in a direction tangential to circular side wall thereof, at a high point thereon, allowing the wash fluid to wash the side wall in a circular and downward motion, at an end of a dissolution test.

Referring to FIG. 8, the schematic diagram therein shows one replicate of fluidics and combination of functional components of the second dissolution testing apparatus in use with the second dissolution testing cell 40 of FIGS. 4A to 4C for determination of properties of dissolution including hydraulic conductivity and hydraulic resistance in accordance with a preferred embodiment of the invention. The second dissolution testing apparatus shown in FIG. 8 may be best viewed as a modification from the first dissolution testing apparatus in FIG. 7A. A principal difference of the fluidics and combination of functional components shown in FIG. 8, from that shown in FIG. 7A, is presence of a differential pressure transducer 80 and manner in which the differential pressure transducer 80 is disposed in relation to fluid connection ports of the dissolution testing cell 40, by way of an advantageous arrangement of fluid conduits including 801, 803, 806 and 807, as shown (FIG. 8). Specifically, each side of a diaphragm of the differential pressure transducer 80 connects to one of a pair of side openings 43 and 47 (FIG. 4A) via fluid connection ports 432 and 470 (FIG. 8) of dissolution testing cell 40.

In each of the apparatus illustrated in FIGS. 7A and 8 and described above, syringe pump “2” 71, sampling valve 74, and second multi-port selection valve 73, in combination, constitute means for selectively sampling dissolution medium from cell cavity (e.g. 32) of a dissolution testing cell and vessel cavity 756 of cumulative vessel 75 for on-line determination of mass of an ingredient differentially and cumulatively dissolved in the dissolution medium, respectively.

Where a dissolution test requires off-line determination involving, e.g., off-line chromatographic (e.g., HPLC) separation, a fraction collector (i.e., its fraction collection vials) may replace cumulative vessel 75 and the online detector 76. In such a case, differential rates of dissolution may be determined experimentally from fractions collected and cumulative masses dissolved integrated from the differential rates of dissolution. Automated dilution of each fraction collected, to an appropriate concentration suitable for direct off-line analysis (e.g., direct HPLC injection), where dilution may be necessary, may be achieved by way of syringe pump “2” 71 and fresh dissolution medium (diluent) from fluid conduit 705.

Where a dissolved ingredient can be quantified by way of fiber optic spectrophotometric determination, a plurality of fiber optic detectors, one for each replicate of the set up of fluidics depicted in FIGS. 7A and 8, may replace the multi-stream sampling valve 74 and the single detector 76.

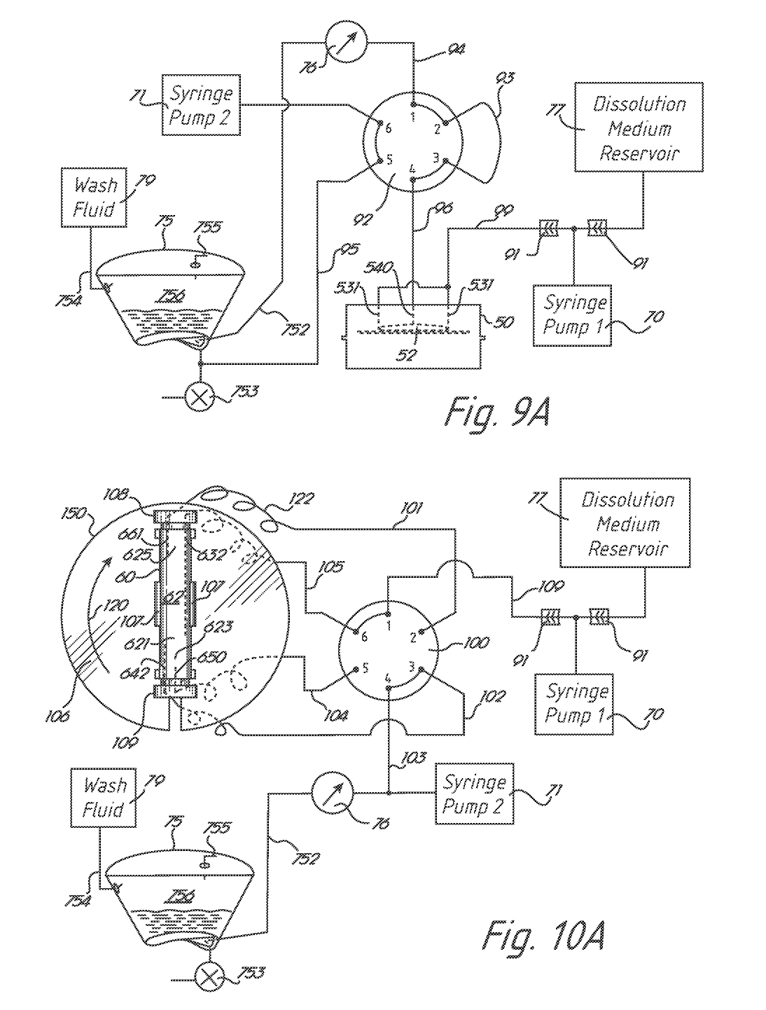

Referring now to FIG. 9A, the schematic diagram therein shows fluidics and combination of functional components of the third dissolution testing apparatus in use with the third dissolution testing cell 50 (FIG. 5B) for determining rate of dissolution of a solid ingredient of a transdermal patch or cream as a function of, at least, cumulative mass of the ingredient dissolved therefrom. The third dissolution testing apparatus comprises: syringe pump “1” 70; syringe pump “2” 71; check valves 91; cumulative vessel six-port switching valve 92; and fluid conduits illustrated by solid line connections, some of which are referenced (e.g., 99, 93, 94, 95, and 96).

Syringe pump “1” 70 withdraws dissolution medium from dissolution medium reservoir 77, and discharges to ports 531 of dissolution testing cell 50 via fluid conduit 99. Check valves 91 ensure uni-direction of flow of the dissolution medium in fluid conduit 99. Fluid conduit 96 connects port 540 of dissolution testing cell 50 to port “4” of six-port switching valve 92. Fluid conduit 93 is a short loop connecting ports “2” and “3” of valve 92. Fluid conduit 94 connects port “1” thereof to detector 76. Detector 76 in the present embodiment is a non-destructive detector (e.g., a UV-visible detector) comprising a flow-through cell. Exit side of the flow-through cell of the detector 76 is connected by fluid conduit 752 to cumulative vessel 75. Fluid conduit 95 connects a lowest point of the cavity of cumulative vessel 75 to port “5” of valve 92. Syringe pump “2” is connected to port “6” of the valve.

During an in vitro dissolution test, valve 92 switches between two positions, a first position as shown in FIG. 9A and a second position in FIG. 9B. Referring to FIG. 9A, the valve being in the presently shown first position, a discharge from syringe pump “1” 70 enters cell cavity 52 of dissolution testing cell 50 via ports 531, exiting therefrom via port 540, entering valve 92 via port “4”, passing through loop 93, leaving valve 92 at port “1”, reaching detector 76 via fluid conduit 94, and, after detection by detector 76, entering vessel cavity 756 of cumulative vessel 75. The detection (of mass of an ingredient dissolved in dissolution medium exiting from dissolution testing cell 50 per unit time) allows determination of differential rate of dissolution of the ingredient dissolving from a transdermal patch or cream sample placed in the dissolution testing cell 50.

Upon determining a value of differential rate of dissolution as described above, syringe pump “2” 71 withdraws a sample of contents of vessel cavity 756 via fluid conduit 95, by way of ports “5” and “6” of valve 92. Upon valve 92 switching subsequently to the second position (FIG. 9B) in a next step, syringe pump “2” 71 discharges the sample of contents withdrawn from vessel cavity 756 to detector 76 via ports “6” and “1” of valve 92, for the determining of cumulative mass of the ingredient dissolved therein. At the same time, syringe pump “1” 70 refills from dissolution medium reservoir 77.

Where the detection of a dissolved ingredient requires a destructive detector 76 (e.g., a mass spectrometer), or simply an FIA technique is desired for the detection, a skilled artisan taught by the present disclosure will be able to replace the flow-through detector 76 (FIG. 9A) with an FIA sampling valve, and provide an FIA carrier solvent to the sampling valve to send contents of a sample loop thereof to detector 76, in a manner similar to that shown and described for, e.g., the first dissolution testing apparatus (FIG. 7A) herein above.

Turning now to FIG. 10A, the schematic diagram therein shows fluidics and a combination of functional components of the fourth dissolution testing apparatus in use with the fourth dissolution testing cell 60 (FIG. 6C) for the determining of vertical velocity of fluidization of a dissolving particulate of a solid dosage product and for the determining of other properties of dissolution of a dissolving ingredient thereof, each as a function of, at least, cumulative mass of the ingredient dissolved therefrom. The fourth dissolution testing apparatus (FIG. 10A) comprises: syringe pump “1” 70; syringe pump “2” 71; check valves 91; cumulative vessel 75; six-port switching valve 100; rocker assembly 150; and fluid conduits illustrated by solid line connections several of which are referenced at 109, 101, 102, 103, 104, and 105. Rocker assembly 150 comprises, in the present embodiment: a vertically disposed turntable 106; means 107 for holding a fourth dissolution testing cell 60 in position on the vertically disposed turntable; first end connection means 108; and, second end connection means 109. First end connection means 108 connects one end of fluid conduit 101 to port 661 of dissolution testing cell 60, and one end of fluid conduit 105 to port 632 thereof Second end connection means 109 connects one end of fluid conduit 102 to port 642 of dissolution testing cell 60, and one end of fluid conduit 104 to port 650 thereof The other end of fluid conduit 101, fluid conduit 105, fluid conduit 102, and fluid conduit 104, connects to port “2”, port “6”, port “3”, and port “5”, respectively, of six-port switching valve 100, as shown. Fluid conduits 101, 105, 102, and 104 each comprise a flexible length (drawn in spirals, e.g., 122) near turntable 106, so that turntable 106 can freely rock between its two positions.

Syringe pump “1” 70 withdraws dissolution medium from dissolution medium reservoir 77, and discharges to port “1” of six-port switching valve 100 via fluid conduit 109. Check valves 91 ensure flow of dissolution medium in the direction indicated by arrows of the drawing symbols 91. Fluid conduit 103 connects port “4” of six-port switching valve 100 to one side of flow-through cell of non-destructive detector 76, while syringe pump “2” 71 tees in therebetween. The other side of flow-through cell of 76 connects to cumulative vessel 75 via conduit 752.

In an in vitro dissolution test, valve 100 switches among three positions, a first position as shown in FIG. 10A, a second position FIG. 10C, and a third position FIG. 10D. Turntable 106 rotates clockwise 120 and counter-clockwise 121 between two positions, a first position as shown in FIG. 10A, and a second position FIG. 10B.

Referring to FIG. 10A, valve 100 being in the presently shown first position, ports 650 and 661 of dissolution testing cell 60 are closed off by valve 100. A discharge from syringe pump “1” 70, at controlled flow rate, creates a flow, at the controlled flow rate, entering cell cavity 62 of dissolution testing cell 60 via port 632, after passing through ports “1” and “6” of valve 100. The flow exits cell cavity 62 via port 642, entering valve 100 again via port “3”, by way of conduit 102, leaving 100 via port “4”, and passing through flow cell of detector 76 before being accumulated in cumulative vessel 75. Upon turntable 106 rapidly rotating (i.e., rocking) counter-clockwise to the presently shown first position (FIG. 10A), from its second position (FIG. 10B) in which a particulate or particulates of a sample under testing had settled to first end 625 of cell cavity 62, the particulate or particulates start to re-settle from first end 625 to second end 623. An ingredient dissolved in the flow in analytical section 621, upon a particulate containing the ingredient passing through the analytical section after settlement from first end 625, is detected by detector 76. Time taken for the particulate to reach the analytical section is used to compute vertical velocity of fluidization of the particulate after calibration against a standard of a known vertical velocity of fluidization.

In FIG. 10C, valve 100 being in the second position, ports 632 and 642 of dissolution testing cell 60 are closed off by valve 100. With turntable 106 in its second position (FIG. 10B), and a particulate or particulates of a sample having settled to first end 625 of cell cavity 62, fresh dissolution medium is delivered by syringe pump “1” 70, enters cell cavity 62 via port 661 of cell 60 by way of ports “1” and “2” of valve 100, and exits cell cavity 62 via port 650, filling 62 with a column of fresh dissolution medium for a next cycle of particulate re-settling and the determining of vertical velocity of fluidization. Determining the mass of an ingredient dissolved in dissolution medium exited from 62 allows computation of differential rate of dissolution of the ingredient (as mass dissolved per cycle) under a discrete settlement hydrodynamic dissolution condition (similar to mode five of using first dissolution testing cell 30). Dividing the mass by twice distance between 625 and 623 yields mass dissolved per unit linear vertical distance of settlement (in the present example, each cycle of the determining consists of two cycles of discrete settlement, i.e., from 625 to 623 and back).

In FIG. 10D, valve 100 being in its third position, fluid conduit 103 being closed off at port “4” of valve 100, syringe pump “2” 71 withdraws a sample of content of cumulative vessel 75. The sample of content withdrawn passes through non-destructive detector 76, allowing determination of cumulative mass of an ingredient dissolved therein (from determined concentration and known volume of fluid in 756).

While the disclosure herein includes description and/or graphic depiction of certain details and specific embodiments of the invention, it is understood that the details and embodiments are for an illustrative purpose only (i.e., for the illustration of one or more general features of the invention) and not intended to be a representation of all possible details and embodiments of the invention. Accordingly, the invention is not limited to the details and specific embodiments, but in scope, which will be recited in appended claims, embraces any and all equivalents of the details and embodiments, modifications thereto, combinations and re-combinations of inventive features thereof, and embodiments comprising a minimum of limiting elements of one or more of the appended claims, all as apparent to those having ordinary skills in the art, taught by the present disclosure.

The term “mathematical transformation (of a metric, i.e., that which is measured, e.g., a property or a variable)”, as used herein, denotes either an act of mathematical operation (on the metric) according to a single-valued mapping, or result of the act, the single-valued mapping providing a one-to-one relationship between any value (of the metric) in domain of the mapping and a corresponding value in range of the mapping. When value (of the metric) in the range is a linear function of value in the domain, i.e., has a linear relationship therewith, the mathematical transformation is also called, herein, “a linear transformation”.

A metric is considered as an equivalent of another if value of the metric has a given one-to-one relationship with value of the another, as the relationship is given by physical law, nature, a given mathematical mapping, or any combination thereof, provided that the relationship is other than, and nor based on, one between the another and the time of a process where the value of the another comes from as a function of the time. A function is an equivalent of another if the function is a mathematical transformation of the another by way of the replacing of a variable with another variable that is an equivalent of the (first) variable.

Equivalents of a metric (including the metric) are sometimes generically called herein “a measure” or “an equivalent measure” of the metric. Equivalents that have a linear relationship with a metric (including the metric) are sometimes generically called herein “a linear measure” of the metric.

What is claimed is:

1-25. (canceled)

26. A method of manufacturing a solid dosage product, comprising the controlling of a measure of each of at least one property comprising a property selected from the group consisting of:
as a function of, at least, a measure of cumulative mass of an ingredient dissolved from a sample of the solid dosage product,
(a.) differential rate of dissolution of the ingredient;
(b.) hydraulic conductivity of a particulate or bed of particulates of the sample; and
(c.) vertical velocity of fluidization of a particulate or particulates of the sample; and over given values of the, at least, a measure of cumulative mass,
(d.) mean value of a linear measure of the differential rate;
(e.) mean value of a linear measure of the hydraulic conductivity; and
(f.) mean value of a measure of the vertical velocity of fluidization;
wherein, each of said function and said linear measures is as empirically determined

27. The method of claim 26, with reference to the selected property, the at least a measure of cumulative mass consisting of the measure of cumulative mass.

28. The method of claim 26, with reference to the selected property, the at least a measure of cumulative mass consisting of the measure of cumulative mass and a measure of an independently variable dissolution medium contact time.

29. The method of claim 26, the selected property being the (a.) differential rate or the (d.) mean value, the measure of (a.) or the linear measure, respectively, being as determined under each of one or more given dissolution conditions, at least a member of the one or more given dissolution conditions being selected from the group consisting of: (A.) discrete fluidization and settlement hydrodynamic condition of a known or calibrated linear vertical distance of local dissolution medium flow per cycle or per unit time; (B.) pressure sensitive packed bed hydrodynamic dissolution condition under a known or calibrated head pressure; (C.) dissolution condition repetitively occurring at first named time points or in first named time periods throughout a dissolution process, among time points or periods of another or other dissolution conditions different from dissolution condition of the first named time points or periods; and (D.) cyclic dissolution condition of an in vitro dissolution process each cycle thereof consisting of a time-series of dissolution conditions each thereof simulating a component dissolution condition of an in vivo dissolution process for a relative duration to length of cycle reflecting probability of occurrence of the component dissolution condition at a point of time in the in vivo dissolution process equal to a point of time of the cycle in the in vitro dissolution process.

30. The method of claim 26, the selected property being the (a.) differential rate, the measure thereof being a member selected from the group consisting of: (A.) mass of the ingredient dissolved per unit linear vertical distance of local dissolution medium flow of a discrete fluidization and settlement hydrodynamic dissolution condition; (B.) mass of the ingredient dissolved per unit linear vertical distance of settlement of a discrete settlement hydrodynamic dissolution condition; (C.) mass of the ingredient dissolved per unit linear distance of local dissolution medium flow of a fixed position hydrodynamic dissolution condition; (D.) mass of the ingredient dissolved per unit linear distance of dissolution medium flow through a packed bed of a pressure-sensitive packed bed hydrodynamic dissolution condition; (E.) mass of the ingredient dissolved per unit time or per cycle of a cyclic dissolution condition; and (F.) any other measure of the (a.) obtained by the scaling of the (a.) with a factor chosen according to one or both of an in vivo dissolution condition and a simulative in vitro dissolution condition.

31. The method of claim 26, the selected property being the (b.) hydraulic conductivity, the measure thereof being a member selected from the group consisting of: (A.) specific hydraulic conductivity to a dissolution medium; (B.) specific hydraulic resistance to a dissolution medium; and (C.) any other measure of the (b.) obtained by the scaling of the (b.) with a factor chosen according to one or both of an in vivo dissolution condition and a simulative in vitro dissolution condition.

32. The method of claim 26, the selected property being the (c.) vertical velocity of fluidization, the measure thereof being a member selected from the group consisting of: (A.) terminal vertical velocity of settlement in a hydrostatic column of a dissolution medium; (B.) time taken to settle through a given vertical distance in a hydrostatic column of a dissolution medium, starting from a given initial vertical velocity of settlement; (C.) vertical distance of settlement through a hydrostatic column of a dissolution medium in a given amount of time, starting from a given initial vertical velocity of settlement; and (D.) vertical velocity of fluidization calibrated or computed from the member (B.) or from the member (C.).

33. The method of claim 26, the selected property being the (d.) mean value, the measure thereof being a member selected from the group consisting of: (A.) mean mass of the ingredient dissolved per unit linear vertical distance of local dissolution medium flow of a discrete fluidization and settlement hydrodynamic dissolution condition; (B.) mean mass of the ingredient dissolved per unit linear vertical distance of settlement of a discrete settlement hydrodynamic dissolution condition; (C.) mean mass of the ingredient dissolved per unit linear distance of local dissolution medium flow of a fixed position hydrodynamic dissolution condition; (D.) mean mass of the ingredient dissolved per unit linear distance of dissolution medium flow through a packed bed of a pressure-sensitive packed bed hydrodynamic dissolution condition; (E.) mean mass of the ingredient dissolved per unit time or per cycle of a cyclic dissolution condition; and (F.) mean value of any other linear measure of the differential rate obtained by the linear scaling of the differential rate with a factor chosen according to one or both of an in vivo dissolution condition and a simulative in vitro dissolution condition.

34. The method of claim 26, the selected property being the (d.) mean value, the given values of the, at least, a measure of cumulative mass consisting of a continuous, given interval of the measure of cumulative mass, the measure of (d.) being a member selected from the group consisting of:
(A.) AUrMC, defined as ∫_{A}^{B}r(M)·dM, where the pair of values A and B denotes boundaries of the given interval, and the r(M) the linear measure expressed as a function of the measure of cumulative mass; (B.) mean differential rate over mass, defined as AUrMC/(B−A); (C.) mean dissolution time, defined as (B−A)/AUrMC; and (D.) any of the members (A.) to (C.) scaled with a factor chosen according to one or both of an in vivo dissolution condition and a simulative in vitro dissolution condition; wherein, preferably, each value of the linear measure at a given value of the measure of cumulative mass is as determined at a dissolution medium contact time effectively equal to time of an in vivo dissolution process at which time the measure of cumulative mass dissolved from a sample of the solid dosage product in the in vivo process is at said given value.

35. The method of claim 26, the selected property being the (a.), the (b.) or the (c.), the at least a measure of cumulative mass consisting of the measure of cumulative mass, each value of the measure of the selected property, at a given value of the measure of cumulative mass in the function for the selected property, being as determined at a dissolution medium contact time effectively equal to a dissolution time of an in vivo dissolution process at which dissolution time the measure of cumulative mass of the ingredient dissolved from a sample of the solid dosage product in the in vivo dissolution process is at said given value.

36. The method of claim 26, the selected property being the (a.), the (b.) or the (c.), value of the measure of the selected property, at each of a plurality of given values of the, at least, a measure of cumulative mass in the function for the selected property, being an average of values of the measure of the selected property, the average being as determined over replicates of the sample of the solid dosage product each at a same given value of the measure of cumulative mass dissolved therefrom.

37. The method of claim 26, the selected property being the (a.), the (b.) or the (c.); the controlling comprising the determining and the evaluating of the measure of the selected property;
the evaluating comprising the comparing of result of the determining to a specification on both an average of the measure of the selected property and variability of the average, at each of a plurality of given values of the, at least, a measure of cumulative mass; the controlling comprising the causing or ensuring of the measure of the selected property to meet said specification; and, said average and said variability being as determined over replicates of the sample of the solid dosage product each at a same given value of the measure of cumulative mass dissolved therefrom.

38. The method of claim 26, the selected property being the (d.), the (e.) or the (f.); the controlling comprising the determining and the evaluating of the measure of the selected property; the evaluating comprising the comparing of result of the determining to a specification on both an average of the measure of the selected property and variability of the average; the controlling comprising the causing or ensuring of the measure of the selected property to meet said specification; and, said average and said variability being as determined over replicates of the sample of the solid dosage product each over said given values.

39. The method of claim 26, the selected property being the (a.) differential rate; the controlling comprising the determining and the evaluating of the measure of the selected property; the evaluating comprising the comparing of output of a computational simulation with a specification on the output, input to the computational simulation comprising result of the determining either as is or after a mathematical manipulation; and, the controlling comprising the causing or ensuring of said output to meet said specification.

40. The method of claim 26, the controlling comprising:
monitoring a measure of one or more members selected from a group consisting of: (A.) attribute or composition of a raw material used in production of the solid dosage product; (B.) process variable in production thereof; and (C.) property of an intermediate product thereof; and
making a manufacturing decision based on result of the monitoring and a validated physical relationship between the measure of one or more members and the measure of the selected property.

41. The method of claim 26, the selected property being the (a.) differential rate or the (d.) mean value; the measure of (a.) or the linear measure, respectively, being as determined under each of one or more given dissolution conditions at least a member thereof comprising a hydrodynamic dissolution condition which subjects a sample of the solid dosage product to dissolution in a fluidized state;
either at least another member of the one or more given dissolution conditions comprising another hydrodynamic dissolution condition which subjects a sample of the solid dosage product to dissolution in a settled state, or the at least one property further comprising the (b.) hydraulic conductivity or the (e.) mean value.

42. The method of claim 26, the at least one property comprising either or both of the (a.) differential rate and the (d.) mean value, and further comprising either or both of the (c.) vertical velocity and the (f.) mean value.

43. The method of claim 26, the at least one property comprising either or both of the (b.) hydraulic conductivity and the (e.) mean value.

44. The method of claim 36, the replicates of the sample each further having a dissolution medium contact time effectively equal to a dissolution time of an in vivo dissolution process at which dissolution time the measure of cumulative mass of the ingredient dissolved from a sample of the solid dosage product in the in vivo dissolution process is at said same given value.

45. The method of claim 36, the selected property being the (a.), the determining being further under a same given homogenous or pseudo-homogenous physicochemical and hydrodynamic dissolution condition.

46. The method of claim 36, the selected property being the (a.), the determining being further under a same given physicochemical dissolution condition and each of several different fundamental hydrodynamic dissolution conditions, said average being a weighted average, and a weight therefor reflecting the probability of a sample of the solid dosage product dissolving under a member of the several different fundamental hydrodynamic dissolution conditions at a point of time in an in vivo dissolution process at which point of time the measure of cumulative mass of the ingredient dissolved therefrom is at said same given value.

47. A method of testing a solid dosage product, comprising the determining and the evaluating of a measure of each of at least one property comprising a property selected from the group consisting of:
as a function of, at least, a measure of cumulative mass of an ingredient dissolved from a sample of the solid dosage product,
(a.) differential rate of dissolution of the ingredient;
(b.) hydraulic conductivity of a particulate or bed of particulates of the sample; and
(c.) vertical velocity of fluidization of a particulate or particulates of the sample; and over given values of the, at least, a measure of cumulative mass,
(d.) mean value of a linear measure of the differential rate;
(e.) mean value of a linear measure of the hydraulic conductivity; and
(f.) mean value of a measure of the vertical velocity of fluidization;
wherein, each of said function and said linear measures is as empirically determined

48. A dissolution testing cell comprising: a cell cavity and at least one opening thereto selected from the group consisting of: (a.) tangential opening, disposed either on a side wall of an axially symmetrical section of the cell cavity or in a peripheral portion of an end wall of the axially symmetrical section, oriented to a given circular direction and in fluid communication with a fluid connection port of the cell; and (b.) ring-shaped opening, disposed on side wall of the cell cavity away from ends thereof and fitted with a ring-shaped filter inner side thereof forming a part of the side wall, and outer side thereof being in fluid communication with a fluid connection port of the cell.

49. A dissolution testing apparatus comprising: (a.) first pump means driving a stream of dissolution medium at a controlled or programmed flow rate; (b.) second pump means withdrawing a sample from a liquid or driving a sample out of a liquid; (c.) cumulative vessel storing a solute dissolved in a dissolution medium exited from a dissolution testing cell during a dissolution test; (d.) detection means either detecting a solute dissolved in a dissolution medium or providing a sample for the detecting; (e.) first switching valve means switching among at least two positions comprising first position and second position, the first position allowing a sample from the dissolution testing cell to travel to the detection means via a fluid conduit, under aid from either one or both of the first and the second pump means, and the second position a sample from the cumulative vessel; and (f.) control means controlling at least the independent functioning of the first and the second pump means, and the functioning of the first switching valve means.
